(19) United States
(12) Patent Application Publication
(10) Pub. No.: US 2003/0149607 A1
(43) Pub. Date: Aug. 7, 2003

(54) Information processing technique associated with snow removal

(75) Inventors: Takiji Ogasawara, Aomori (JP); Takashi Yugami, Aomori (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/269,854

(22) Filed: Oct. 15, 2002

(30) Foreign Application Priority Data
Feb. 5, 2002 (JP) 2002-028786

(51) Int. Cl. G06F 17/60

(52) U.S. Cl. 705/8

(57) ABSTRACT

An object of this invention is to provide an information processing technique in which consideration for snowily weak people, such as old people or handicapped people, in snow removal work is made in a suitable form. This information processing method includes the steps of: generating data (for example, priority patrol spot symbol □, snow clearing complaint spot symbol X, snow dumping complaint spot symbol Δ) indicating the necessity of snow removal with a reason other than the snowily weak person based on position information of a registered snowily weak person; and transmitting map information (FIG. 18) including data indicating the necessity of the snow removal in response to the request from a terminal of a person relating to a snow removal plan. By doing so, it becomes possible to exhibit the necessity of the snow removal to the person relating to the snow removal plan without specifying the snowily weak person. This is because when the snowily weak person is specified, there is a case where a problem occurs in prevention of crimes.

### TECHNICAL FIELD OF THE INVENTION

The present invention relates to an information processing technique associated with snow removal.

### BACKGROUND OF THE INVENTION

Conventionally, snow removal work has been contrived in such a manner that principle roads are divided into the respective routes, an urban area other than those is divided into small snow removal work zones, most of them are in charge of separate snow removal agencies, and the work is carried out on the basis of instructions from a local government such as a city office. However, it is very difficult for the local government to grasp all states of the snow removal work in the respective work zones, and even if the local government receives complaints against the result of the snow removal work or inquiries about the snow removal work, it can not respond to the respective complaints and inquiries. Besides, it is also difficult to ascertain the genuineness of working reports from the snow removal agencies, and it has taken a great deal of labor and time with respect to the processing of the working reports. Incidentally, a technique about the record of execution of snow removal is disclosed in Japanese Patent Laid-Open No. S63-297615 and No. S63-297617.

Also for citizens receiving the snow removal service, a complaint against a snow removal agency has been hard to convey, and it has also been difficult to obtain information of a snow removal plan. Further, consideration for a snowily weak person household such as an old person or handicapped person has not been satisfactory.

It has been impossible also for a snow removal agency to make a snow removal plan in due consideration of the information of complaints and/or the information of the snowily weak person, and it has not been impossible to improve the satisfaction of citizens with respect to the snow removal work. Besides, it has taken a great deal of trouble and time to prepare a working report.

### SUMMARY OF THE INVENTION

An object of the invention is therefore to provide a technique in which information exchange and information processing required in snow removal work can be efficiently carried out.

Another object of the invention is to provide an information processing technique in which in snow removal work, consideration for snowily weak people such as old people or handicapped people is made in a suitable way.

According to the invention, an information processing method associated with snow removal comprises the steps of: generating data indicating necessity of snow removal with a reason other than a snowily weak person based on position information of a registered snowily weak person; and transmitting map information including said data indicating necessity of snow removal in response to a request from a terminal of a person relating to a snow removal plan. By doing so, it becomes possible to exhibit the necessity of the snow removal to the person relating to the snow removal plan without specifying the snowily weak person is concerned. This is because if the snowily weak person is specified, there is also a case where a problem occurs in prevention of crimes.

Incidentally, it is also possible to make the aforementioned data indicating the necessity of the snow removal include data based on a complaint from a citizen, or include data based on a monitor spot by a person responsible in a local government. A planner of the snow removal plan can make an efficient snow removal plan in view of positions to be addressed, such as a complaint report spot or the monitor spot. Incidentally, since the position of the snowily weak person gets mixed with such information and is exhibited, the planner of the snow removal plan can not recognize the snowily weak person.

Besides, there is also a case where the aforementioned data indicating the necessity of the snow removal includes data indicating a degree of necessity. By this, the planner of the snow removal plan can preferentially incorporate a place having a high degree of necessity into the plan.

Besides, there is also a case where the data indicating the degree of necessity is determined on the basis of a volume of a snow accumulation or a snowfall. It maybe determined on the basis of the number of complaints. Besides, with regard to the snowily weak person, the degree of necessity specified by a person responsible in a local government may be used.

Besides, the method may further comprise a step of receiving and storing into a storage, information of a snow-removal work scheduled area from a terminal of the planner of the snow removal plan.

Further, the method may further comprise the steps of: receiving information concerning an execution state of snow removal work and storing it in the storage device; and transmitting map information including information on the snow-removal work scheduled area and the execution state of the snow removal work to a user terminal in response to a request from the user terminal. It becomes possible to grasp the general situation including the schedule and the execution state.

Moreover, the method may further comprise the steps of: receiving information on an execution state of snow removal work and storing it in a storage device; and generating and transmitting information for a snow-removal work report on the basis of information on the execution state of the snow removal work in response to a request from a terminal of an executer of the snow removal work. By this, it becomes possible to improve working efficiency of the snow removal agency and the person responsible in the local government.

Incidentally, a terminal of the person relating to the snow removal plan executes the steps of: transmitting a request for information concerning the snow removal plan to a server; and receiving map information including a complaint report position display and a position display of the snowily weak person as data indicating necessity of snow removal with a reason other than the snowily weak person, and displaying it on a display device.

The aforementioned method can be executed through a program and a computer. This program is stored in a storage medium or a storage device such as, for example, a flexible disk, a CD-ROM, a magneto-optical disk, a semiconductor memory, or a hard disk. Besides, there is also a case where the program is distributed through a network or the like. Incidentally, an intermediate processing result is temporarily held in a memory.

### BRIEF DESCRIPTION OF THE DRAWINGS

FIG. 1 is a drawing showing an example of a system configuration in an embodiment of the invention;

FIG. 2 is a drawing showing an example of data stored in a snow-removal work completion master DB;

FIG. 3 is a drawing showing an example of data stored in a claim master DB;

FIG. 4 is a drawing showing an example of data stored in a map master DB;

FIG. 5 is a drawing showing an example of data stored in an advertisement master DB;

FIG. 6 is a drawing showing an example of data stored in an initial value master DB;

FIG. 7 is a drawing showing an example of data stored in an agency master DB;

FIG. 8 is a drawing showing an example of data stored in a snowily weak person master DB;

FIG. 9 is a drawing showing an example of data stored in a snowplow master DB;

FIG. 10 is a drawing showing an example of a point table;

FIG. 11 is a drawing showing an example of data stored in a schedule master DB;

FIG. 12 is a drawing showing an example of data stored in a fixed camera master DB;

FIG. 13 is a drawing showing an example of data stored in a priority patrol master DB;

FIG. 14 is a drawing showing an example of a menu screen for a snow removal agency;

FIG. 15 is a drawing showing a processing flow at the time when a snow removal plan is generated;

FIG. 16 is a drawing showing an example of a screen for selecting a date of a snow removal plan;

FIG. 17 is a drawing showing a second portion of a processing flow at the time when the snow removal plan is generated;

FIG. 18 is a drawing showing an example of a screen displayed at the time when the snow removal plan is generated;

FIG. 19 is a drawing showing a third portion of a processing flow at the time when the snow removal plan is generated;

FIG. 20 is a drawing showing an example of a screen displayed at the time when the snow removal plan is generated;

FIG. 21 is a drawing showing an example of a screen displayed at the time when the snow removal plan is generated;

FIG. 22 is a drawing showing a processing flow at the time when a work completion report is made;

FIG. 23 is a drawing showing an example of a screen displayed at the time when the work completion report is made;

FIG. 24 is a drawing showing an example of a menu screen for citizens;

FIG. 25 is a drawing showing a processing flow for claim input;

FIG. 26 is a drawing showing an example of a screen for work area selection;

FIG. 27 is a drawing showing an example of a screen displayed at the time of claim position designation;

FIG. 28 is a drawing showing an example of a screen of claim content input;

FIG. 29 is a drawing showing a processing flow for fixed camera designation;

FIG. 30 is a drawing showing an example of a screen displayed at the time of fixed camera designation;

FIG. 31 is a drawing showing a processing flow for displaying a fixed camera image;

FIG. 32 is a drawing showing an example of a screen for displaying a fixed camera image;

FIG. 33 is a drawing showing a processing flow for displaying snow-removal achievement to a citizen computer;

FIG. 34 is a drawing showing an example of a snow-removal achievement display screen;

FIG. 35 is a drawing showing an example of a menu screen for a citizen monitor;

FIG. 36 is a drawing showing a processing flow for monitoring information input for snowily weak person;

FIG. 37 is a drawing showing an example of a screen for monitoring information input for snowily weak person;

FIG. 38 is a drawing showing an example of a menu screen for a city office;

FIG. 39 is a drawing showing a processing flow for initial setting;

FIG. 40 is a drawing showing an example of a screen for inputting an initial value setting;

FIG. 41 is a drawing showing a processing flow for priority snow-removal master maintenance;

FIG. 42 is a drawing showing an example of a screen for a priority snow-removal master maintenance;

FIG. 43 is a drawing showing a processing flow for displaying places of patrol and priority snow removal and measure-required places;

FIG. 44 is a drawing showing an example of a display screen to indicate places of patrol and priority snow removal and measure-required places;

FIG. 45 is a drawing showing a processing flow for snow-removal achievement display to a city office computer and a snow removal agency computer;

FIG. 46 is a drawing showing a screen of snow removal general situation;

FIG. 47 is a drawing showing a processing flow of a batch processing of claims or the like; and

FIG. 48 is a drawing showing a point determination processing flow.

### DETAIL DESCRIPTION OF THE PREFERRED EMBODIMENTS

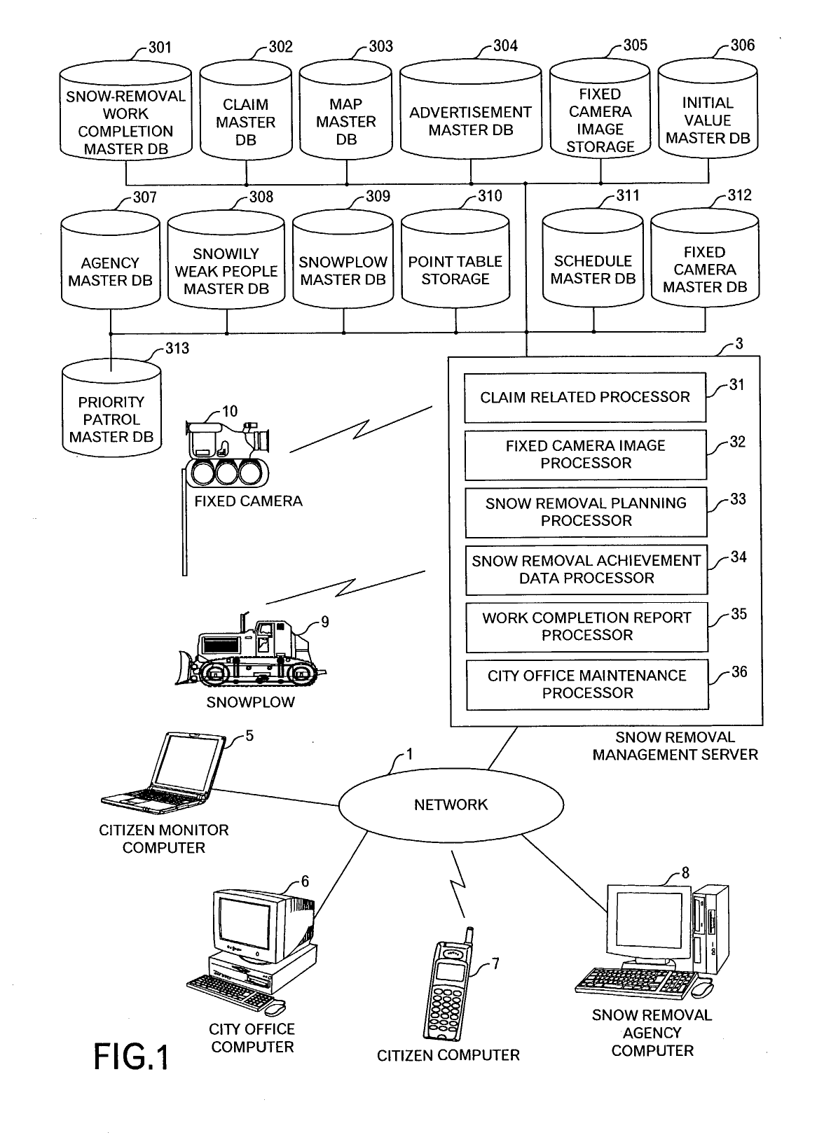

FIG. 1 shows a system outline according to an embodiment of the invention. A network 1, for example, the Internet is connected with a snow removal management server 3 for carrying out main processing in this embodiment, a citizen monitor computer 5, for example, a personal computer operated by a citizen monitor, a city office computer 6, for example, a personal computer operated by a person responsible in a local government (hereinafter referred to as a city office), a citizen computer 7, for example, a cellular phone operated by a citizen, and a snow removal agency computer 8, for example, a personal computer operated by a person responsible in a snow removal agency. In this embodiment, a snowplow 9 is provided with a GPS (Global Positioning System) equipment and a communication instrument, and information concerning the present position during the snow removal work is transmitted to the snow removal management server 3. It may be transmitted through the network 1. Besides, a fixed camera 10 for taking an image to be provided to citizens and a communication instrument are installed on, for example, a signal, and the image taken by the fixed camera 10 is transmitted to the snow removal management server 3. It may be transmitted through the network 1. Incidentally, the computers used by the citizen, the citizen monitor, the city office and the snow removal agency are not limited to the equipments of the kinds as shown in FIG. 1.

The snow removal management server 3 includes a claim related processor 31 for processing information such as complaints from citizens or states of snowily weak people from citizen monitors, a fixed camera image processor 32 for receiving image information from the fixed camera 10 and transmitting it in response to a request from a citizen or the like, a snow removal planning processor 33 for carrying out a processing for, for example, planning of a snow removal plan and browsing of the snow removal plan by a person responsible in a snow removal agency, a snow-removal achievement data processor 34 for generating and transmitting information concerning an execution state of snow removal in accordance with a request of a person responsible in a city office, a citizen, a person responsible in a snow removal agency or the like, a work completion report processor 35 for carrying out a processing to prepare a work completion report by the person responsible in the snow removal agency, and a city office maintenance processor 36 for carrying out input and browsing of various data by the person responsible in the city office.

Besides, the snow removal management server 3 manages a snow-removal work completion master DB 301 in which information concerning the snow-removal work completion report is stored, a claim master DB 302 for storing information concerning complaints from citizens, a map master DB 303 for storing information of maps to be transmitted from the snow removal management server 3 to various computers, an advertisement master DB 304 for storing information of advertisements exhibited at the time of access by citizens, a fixed camera image storage 305 for temporarily storing image information from the fixed camera 10, an initial value master DB 306 for storing data of weather, and volumes of snow accumulation and snowfall inputted by a person responsible in a city office, an agency master DB 307 for storing information concerning snow removal agencies, a snowily weak person master DB 308 for storing information of snowily weak people such as old people or handicapped people, a snowplow master DB 309 for storing information received from the snowplow 9, a point table storage 310 used when complaints from citizens are transformed into points, a schedule master DB 311 for storing information concerning snow removal plans, a fixed camera master DB 312 for storing information of fixed cameras designated by respective citizens, and a priority patrol master DB 313 for storing information such as a spot which is monitored by the person responsible in the city office with priority.

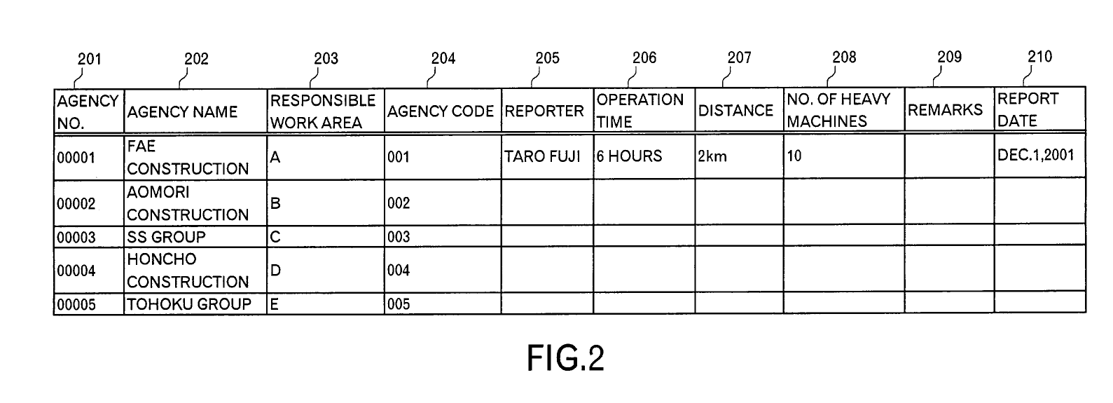

Next, an example of data stored in the snow-removal work completion master DB 301 will be described by the use of FIG. 2. The example of FIG. 2 includes a column 201 of a snow removal agency number (No.), a column 202 of a snow removal agency name, a column 203 of a work area of a snow removal agency, a column 204 of an agency code, a column 205 of a reporter of a snow-removal work completion report, a column 206 of an operating time of a heavy machine in the snow removal work, a column 207 of a working distance of a heavy machine, a column 208 of the number of heavy machines used, a column 209 of a remark in a snow-removal work completion report, and a column 210 of a report date.

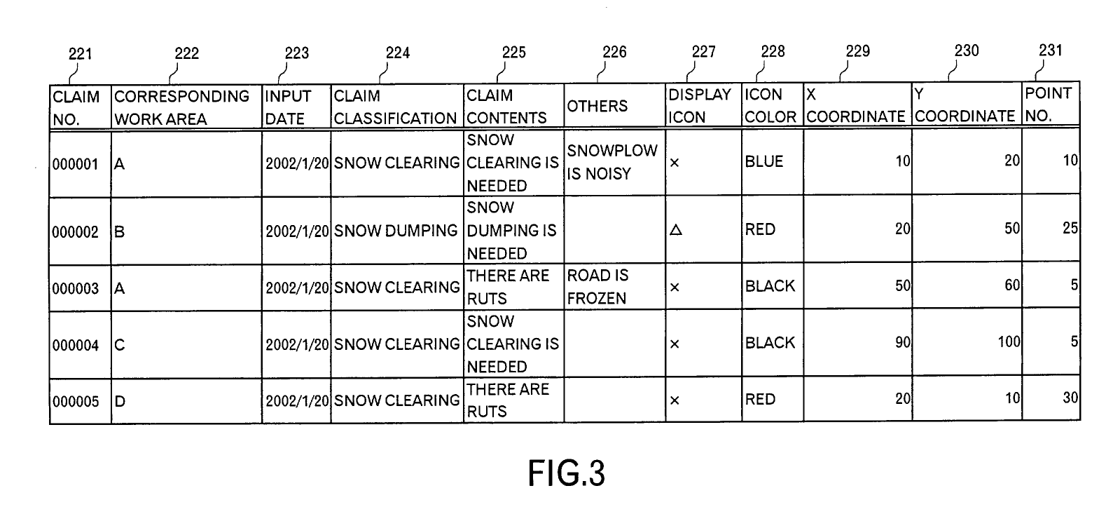

An example of data stored in the claim master DB 302 will be described by the use of FIG. 3. The example of FIG. 3 includes a column 221 of a claim number (No.), a column 222 of a work area corresponding to a claim, a column 223 of a claim input date, a column 224 of claim classification (snow clearing or snow dumping), a column 225 of claim content, a column 226 of other comments, a column 227 of a display icon (snow clearing:X/snow dumping: ΔA) at the time of plotting on a map, a column 228 of an icon color (point number is less than 10: black/point number is not less than 10: blue/point number is not less than 20: red) at the time of plotting on the map, a column 229 of an x coordinate, a column 230 of a y coordinate, and a column 231 of a point number.

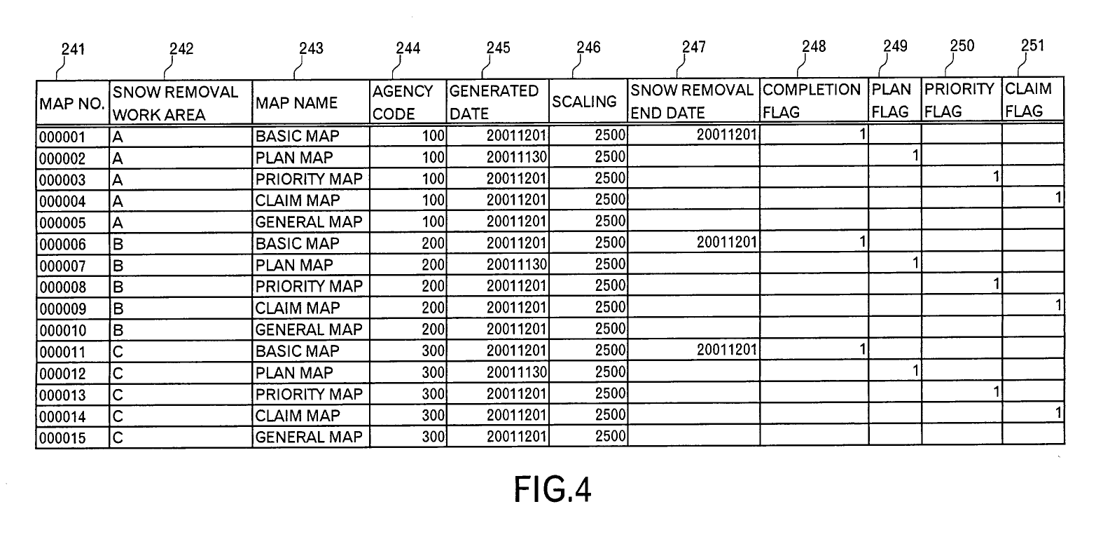

An example of data stored in the map master DB 303 will be described by the use of FIG. 4. Data as shown in FIG. 4 are provided for each date and the example of FIG. 4 includes a column 241 of a map number (No.), a column 242 of a snow-removal work area, a column 243 of a map name, a column 244 of an agency code, a column 245 of a map generation date, a column 246 of a map scale, a column 247 of a snow removal end date, a column 248 of a completion flag which is set to “1” when snow removal work is completed, a column 249 of a plan flag which is set to “1” in the case where a snow-removal work plan is generated, a column 250 of a priority flag which is set to “1” in the case where a person responsible in a city office designates a priority spot, and a column 251 of a claim flag which is set to “1” in the case where a complaint concerning a work area is registered.

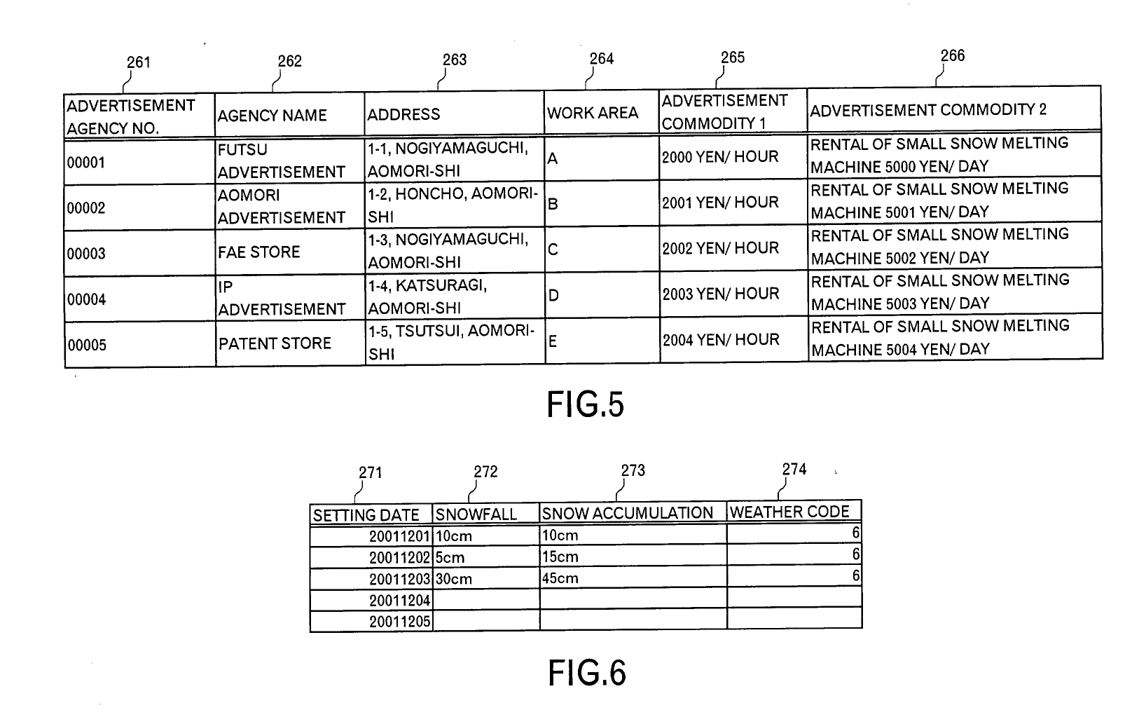

An example of data stored in the advertisement master DB 304 will be described by the use of FIG. 5. The example of FIG. 5 includes a column 261 of an advertisement agency number (No.), a column 262 of an advertisement agency name, a column 263 of an address of an advertisement agency, a column 264 of a work area of an advertisement object, a column 265 of information of an advertisement commodity 1, and a column 266 of information of an advertisement commodity 2.

An example of data stored in the initial value master DB 306 will be described by the use of FIG. 6. The example of FIG. 6 includes a column 271 of a setting date of an initial value, a column 272 of a snowfall, a column 273 of a volume of a snow accumulation, and a column 274 of a weather code (for example, 1: cloudy/2: fine, snow later/3: snow, cloudy later/4: cloudy, snow later/5: snow /6: heavy snow/7: snow, fine later/8: fine/9: fine, cloudy later/10: cloudy, fine later).

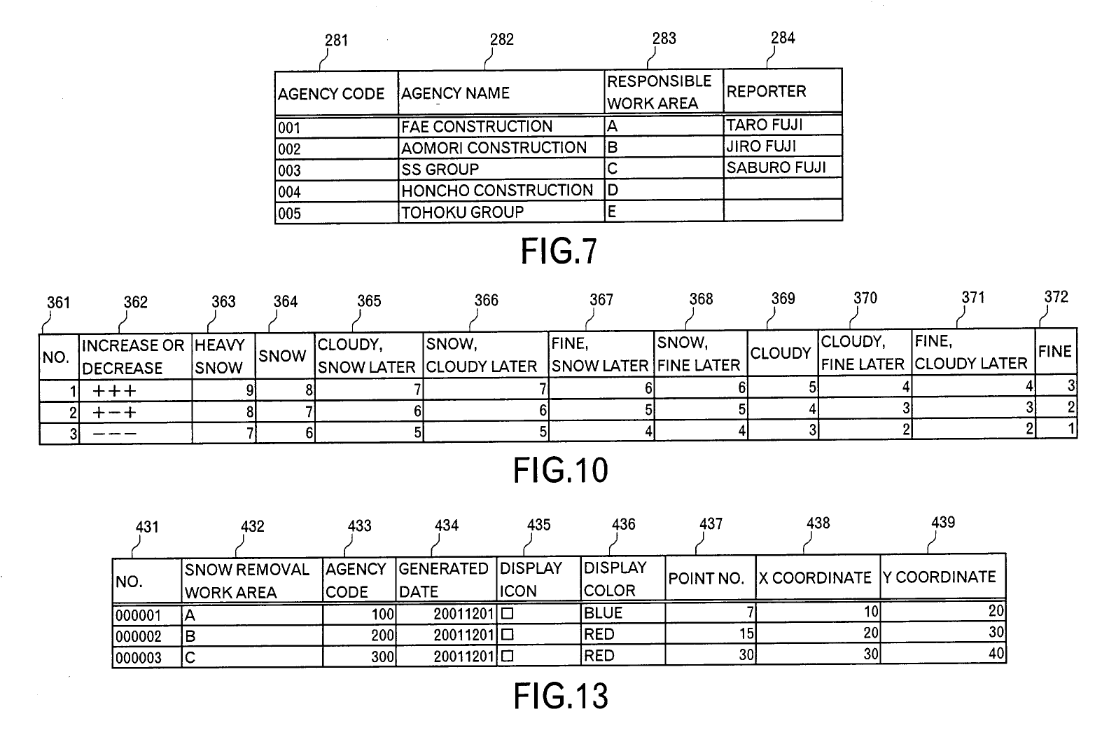

An example of data stored in the agency master DB 307 will be described by the use of FIG. 7. The example of FIG. 7 includes a column 281 of a snow removal agency code, a column 282 of a snow removal agency name, a column 283 of a work area in charge, and a column 284 of a reporter.

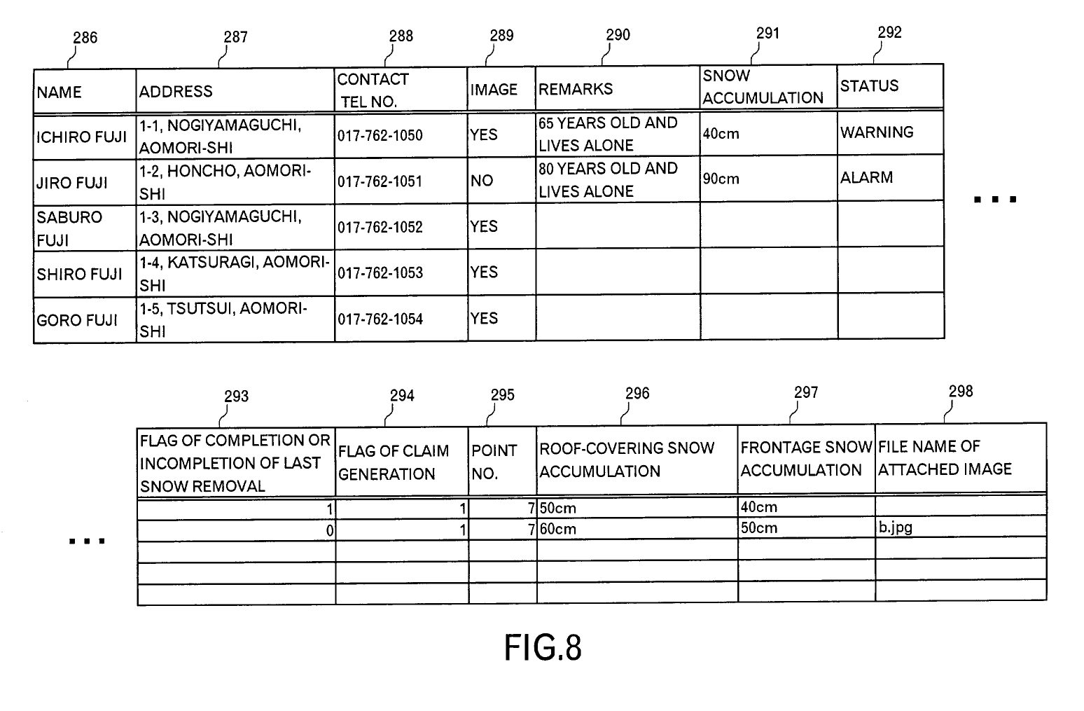

An example of data stored in the snowily weak person master DB 308 will be described by the use of FIG. 8. The example of FIG. 8 includes a column 286 of a name of a snowily weak person, a column 287 of an address of a snowily weak person, a column 288 of a telephone number of contact address, a column 289 indicating whether or not an image representing a state exists, a column 290 of a remark, a column 291 of a volume of a snow accumulation, a column 292 of a status concerning a roof-covering snow accumulation, a column 293 of a flag (1: completion/0: incompletion) indicating whether or not snow removing was carried out last time, a column 294 of a flag (1: generated/0: not generated) indicating whether or not a claim is generated on the basis of snowily weak person information, a column 295 of a point number, a column 296 of a volume of a roof-covering snow accumulation, a column 297 of a volume of a frontage snow accumulation, and a column 298 of a name of an attached image file in the case where the attached image file exists.

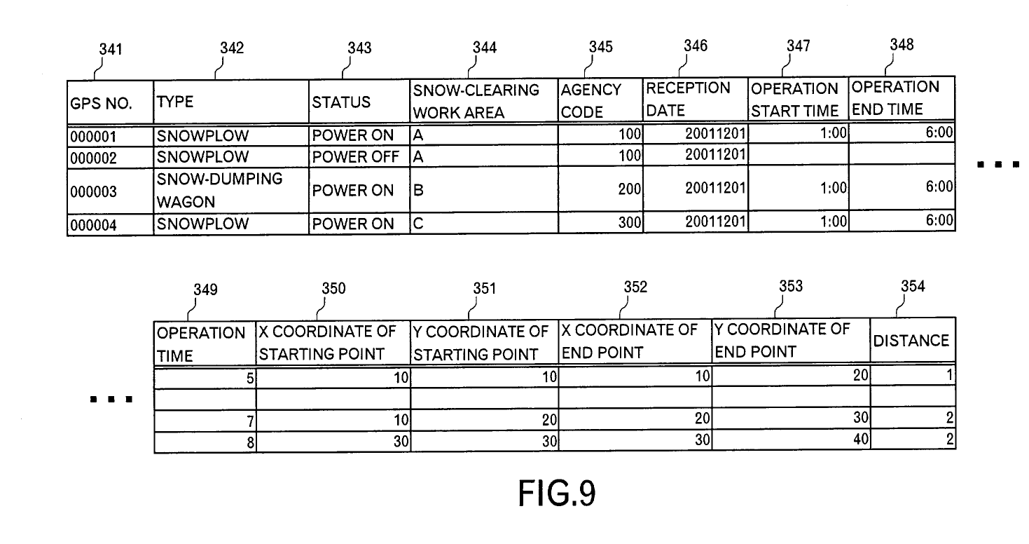

An example of data stored in the snowplow master DB 309 will be described by the use of FIG. 9. The example of FIG. 9 includes a column 341 of a GPS number (No.), a column 342 of a type (snowplow/snow-dumping wagon), a column 343 of a power supply status (ON/OFF) of a GPS equipment, a column 344 of a snow-removal work area under work, a column 345 of a snow removal agency code, a column 346 of a reception date of a signal from the GPS equipment, a column 347 of an operation start time of a snowplow (or GPS equipment), a column 348 of an operation end time, a column 349 of an operating time, a column 350 of an X coordinate of an operation starting point, a column 351 of a Y coordinate of an operation starting point, a column 352 of an X coordinate of an operation end point, a column 353 of a Y coordinate of an end point, and a column 354 of an operation distance.

The GPS equipment of the snowplow 10 transmits the GPS number and the position information to the snow removal management server 3 at any time from the time of the operation start. When the snow removal management server 3 receives the GPS number and the position information, it first stores the operation start time, the X coordinate of the starting point, and the Y coordinate of the starting point into the snowplow master DB 309, and thereafter, stores the operation end time, the X coordinate of the end point, and the Y coordinate of the end point into the snowplow master DB 309, and calculates the operating distance and the operating time to store them into the snowplow master DB 309. If doing so, in a case where information is not sent from the GPS equipment, it is judged that the operation is ended with the final received information. However, information concerning the operation end may be separately transmitted to the snow removal management server 3 from the GPS equipment. The information of the operation start may also be separately sent. Further, the history of data received from the GPS equipment is separately stored.

An example of the point table stored in the point table storage 310 will be described by the use of FIG. 10. In the point table of FIG. 10, a point is determined by the combination of today's weather and any of three cases including a case where the snow accumulation is continuously increased for three days (the case of +++), a case where the snow accumulation is increased and decreased for three days (the case of +−+), and a case where the snow accumulation is continuously decreased for three days (the case of −−−). That is, the point table includes a column 361 of a row number (No.), a column 362 of increase or decrease (+++/+−+/−−−), a column 363 of a point number in the case of heavy snow, a column 364 of a point number in the case of snow, a column 365 of a point number in the case of cloudy, snow later, a column 366 of a point number in the case of snow, cloudy later, a column 367 of a point number in the case of fine, snow later, a column 368 of a point number in the case of snow, fine later, a column 369 of a point number in the case of cloudy, a column 370 of a point number in the case of cloudy, fine later, a column 371 of a point number in the case of fine, cloudy later, and a column 372 of a point number in the case of fine.

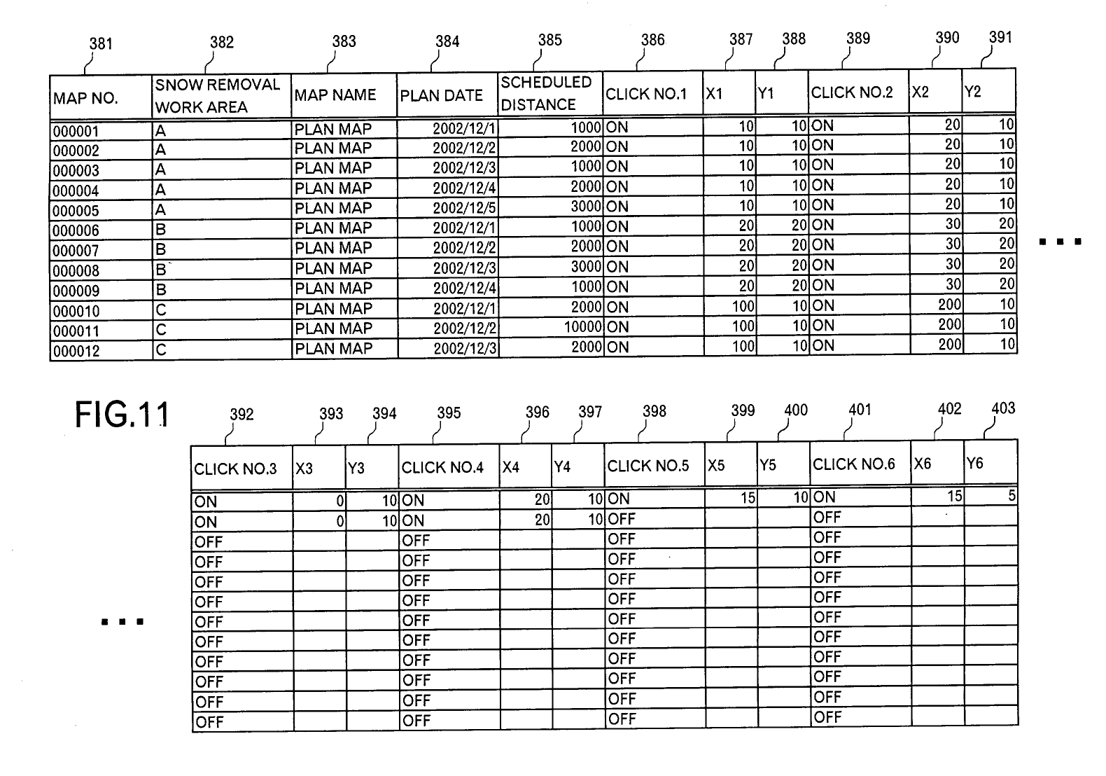

An example of data stored in the schedule master DB 311 will be described by the use of FIG. 11. The example of FIG. 11 includes a column 381 of a number (No.) of a map used for snow removal planning, a column 382 of a snow removal work area, a column 383 of a map name, a column 384 of a plan date, a column 385 of a snow-removal scheduled distance, a column 386 of click number 1 (No. 1) indicating whether or not a first click is made (ON/OFF), a column 387 of a value X1 of an X coordinate of the click, a column 388 of a value Y1 of a Y coordinate of the click, a column 389 of click No. 2 indicating whether or not a second click is made, a column 390 of a value X2 of the X coordinate of the click, a column 391 of a value Y2 of the Y coordinate of the click, a column 392 of click No. 3 indicating whether or not a third click is made, a column 393 of a value X3 of the X coordinate of the click, a column 394 of a value Y3 of the Y coordinate of the click, a column 395 of click No. 4 indicating whether or not a fourth click is made, a column 396 of a value X4 of the X coordinate of the click, a column 397 of a value Y4 of the Y coordinate of the click, a column 398 of click No. 5 indicating whether or not a fifth click is made, a column 399 of a value X5 of the X coordinate of the click, a column 400 of a value Y5 of the Y coordinate of the click, a column 401 of click No. 6 indicating whether or not a sixth click is made, a column 402 of a value X6 of the X coordinate of the click, and a column 403 of a value Y6 of the Y coordinate of the click.

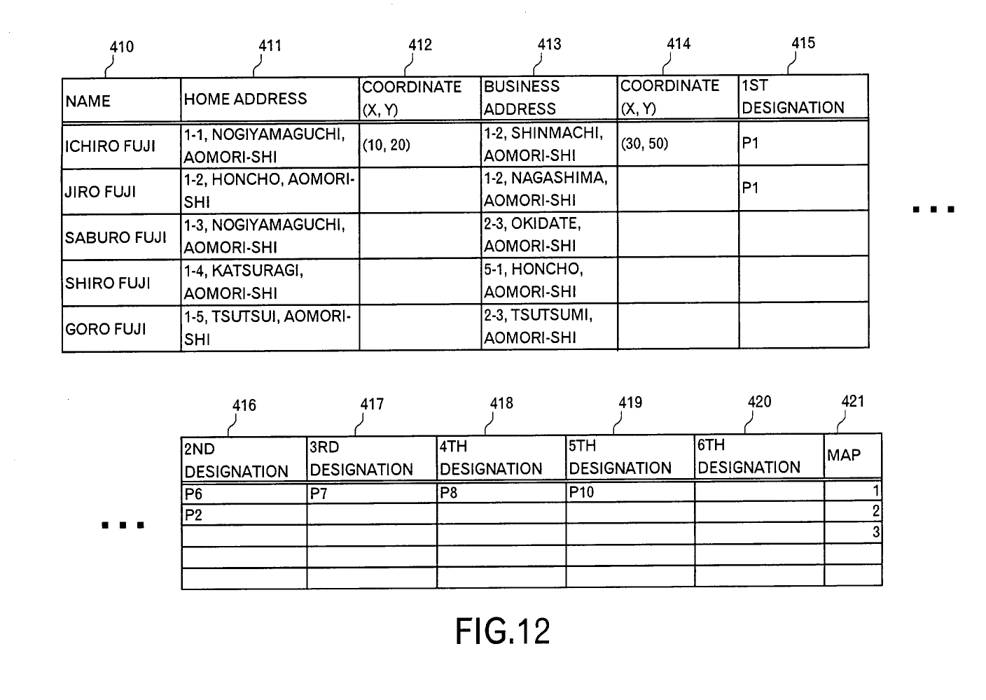

An example of data stored in the fixed camera master DB 312 will be described by the use of FIG. 12. The example of FIG. 12 includes a column 410 of a name of a citizen requesting an image of a fixed camera, a column 411 of a home address, a column 412 of its coordinate value, a column 413 of a business address, a column 414 of its coordinate value, a column 415 of designation 1 as the number of a designated first camera, a column 416 of designation 2 as the number of a designated second camera, a column 417 of designation 3 as the number of a designated third camera, a column 418 of designation 4 as the number of a designated fourth camera, a column 419 of designation 5 as the number of a designated fifth camera, a column 420 of designation 6 as the number of a designated sixth camera, and a column 421 of the number of a map to be used.

An example of data stored in the priority patrol master DB 313 will be described by the use of FIG. 13. The example includes a column 431 of a row number (No.), a column 432 of a snow-removal work area, a column 433 of a code of a snow removal agency in charge, a column 434 of a data generation date, a column 435 of a display icon for displaying a priority patrol spot, a column 436 of a display color, a column 437 of a point number, a column 438 of an X coordinate of the priority patrol spot, and a column 439 of a Y coordinate.

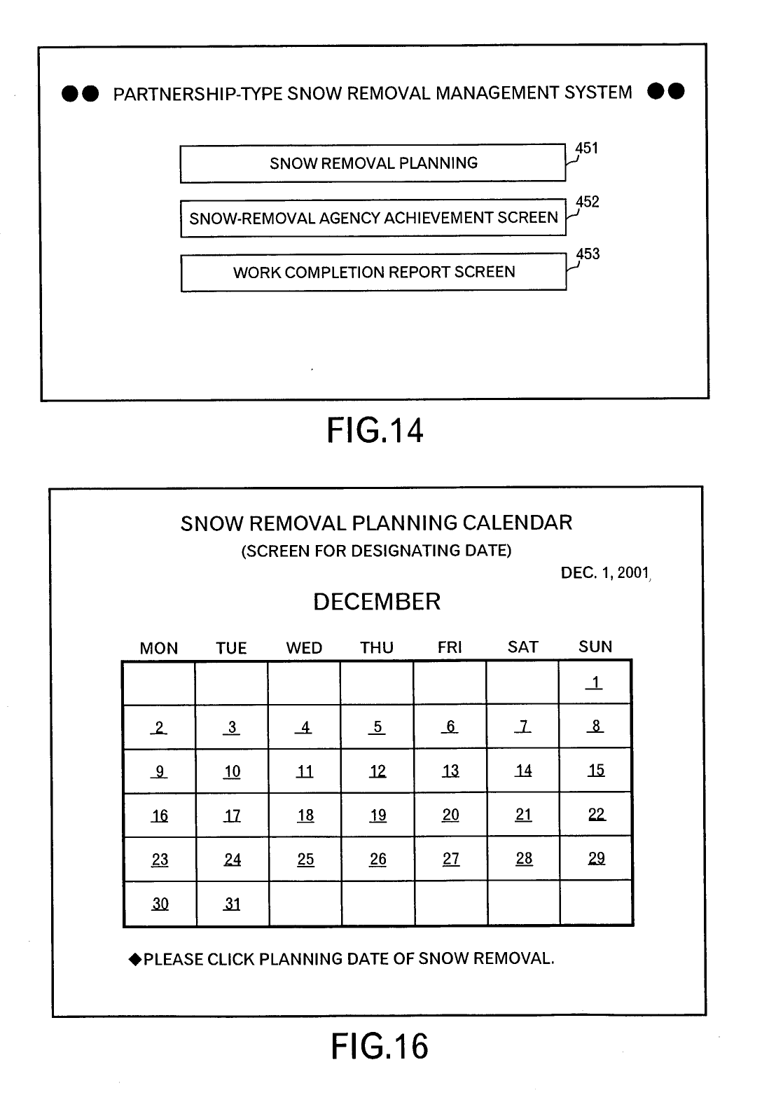

Next, processing of the snow removal management server 3 and the various computers will be described by the use of FIGS. 14 to 48. First, the processing of the snow removal agency computer 8 and the snow removal management server 3 will be described by the use of FIGS. 14 to 23. A person responsible in a snow removal agency operates the snow removal agency computer 8 to access the snow removal management server 3, and after authentication is made through a user ID and a password in the snow removal management server 3, the snow removal agency computer 8 displays a main menu for a snow removal agency, which is shown in FIG. 14, on the basis of Web page data received from the snow removal management server 3. In the example of FIG. 14, there are provided a snow removal planning button 451 to be clicked in the case where a snow removal plan is generated, a snow-removal agency achievement screen button 452 to be clicked in the case where the state of snow removal work is displayed, and a work completion report screen button 453 for preparing a work completion report.

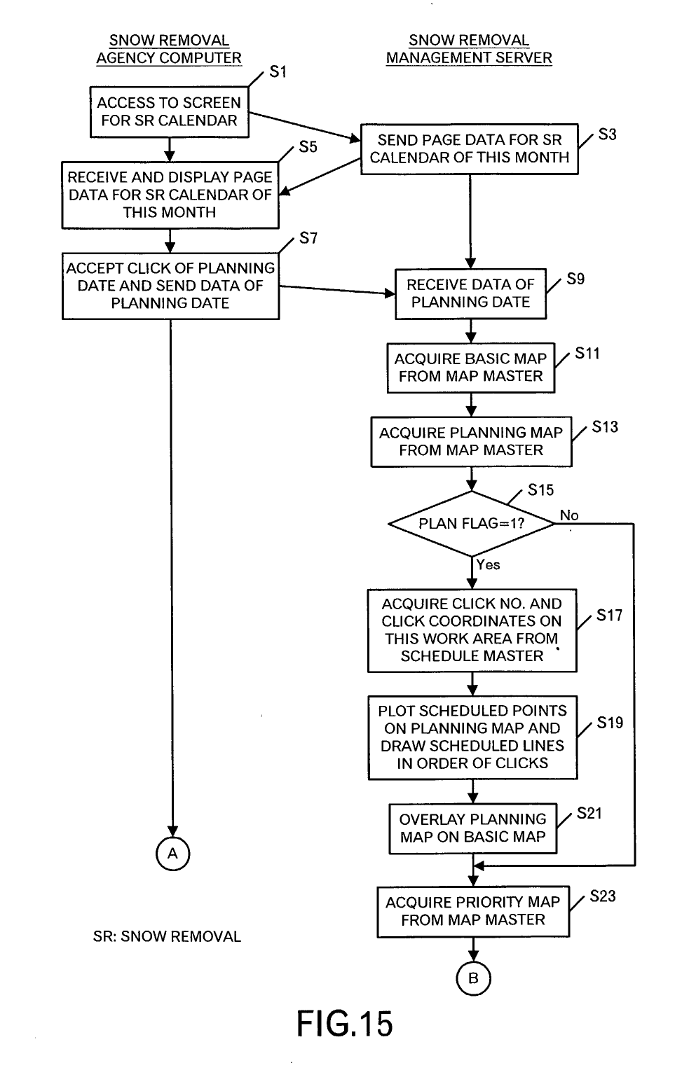

In case the snow removal planning button 451 is clicked, the snow removal agency computer 8 accesses a snow removal calendar screen (FIG. 15: step S1). In response to the access from the snow removal agency computer 8, the snow removal planning processor 33 of the snow removal management server 3 transmits snow-removal calendar page data of the month to the snow removal agency computer 8 (step S3). The snow removal agency computer 8 receives the snow-removal calendar page data of the month from the snow removal management server 3 and displays it on a display device by a Web browser (step S5). For example, a display as shown in FIG. 16 is carried out. In the example of FIG. 16, since a processing date is December 1, a calendar of December, 2001 is shown, and a numeral of each date can be selected. Incidentally, there is also a case where it is made impossible to select a date before the processing date.

The person responsible in the snow removal agency sees the display of FIG. 16, and clicks a numeral of a planning date. The snow removal agency computer 8 accepts the click of the numeral of the planning date by the person responsible in the snow removal agency, and transmits data of the planning date to the snow removal management server 3 (step S7). Then, the snow removal planning processor 33 of the snow removal management server 3 receives the data of the planning date from the snow removal agency computer 8 and temporarily stores it in the storage device (step S9). Then, the snow removal planning processor 33 reads out a basic map of a work area, of which the snow removal agency is in charge, from the map master DB 303 (FIG. 4) (step S11). The basic map is basic map information in which information of complaints and priority patrol is not plotted. Since another map is superposed on the basic map hereinafter, it becomes the background of a map exhibited to the snow removal agency. Besides, a planning map of the work area, of which the snow removal agency is in charge, is read out from the map master DB 303 (FIG. 4).

Then, it is judged whether the plan flag is set to “1” correspondingly to the planning map of the map master DB 303 (step S15). This signifies that it is judged whether or not a snow removal plan of the planning date is already registered before this processing. If the snow removal plan of the planning date is not yet registered, the plan flag is zero, and the processing proceeds to step S23. On the other hand, in the case where the snow removal plan of the planning date is already registered, the combination of the click number and the click coordinates (X coordinate and Y coordinate) of the work area on the planning date is read out from the schedule master DB 311 (FIG. 11) (step S17). Then, scheduled points including the click number are plotted on the planning map in accordance with the click coordinate position, scheduled lines are drawn in the order of click, and the generated planning map is stored in the storage device (may be stored in the map master DB 303) (step S19). The drawing mode of the plot of the scheduled points and the scheduled line will be described later. Then, the planning map generated at the step S19 is overlaid on the basic map read out at the step S11, and they are stored in the storage device (step S21).

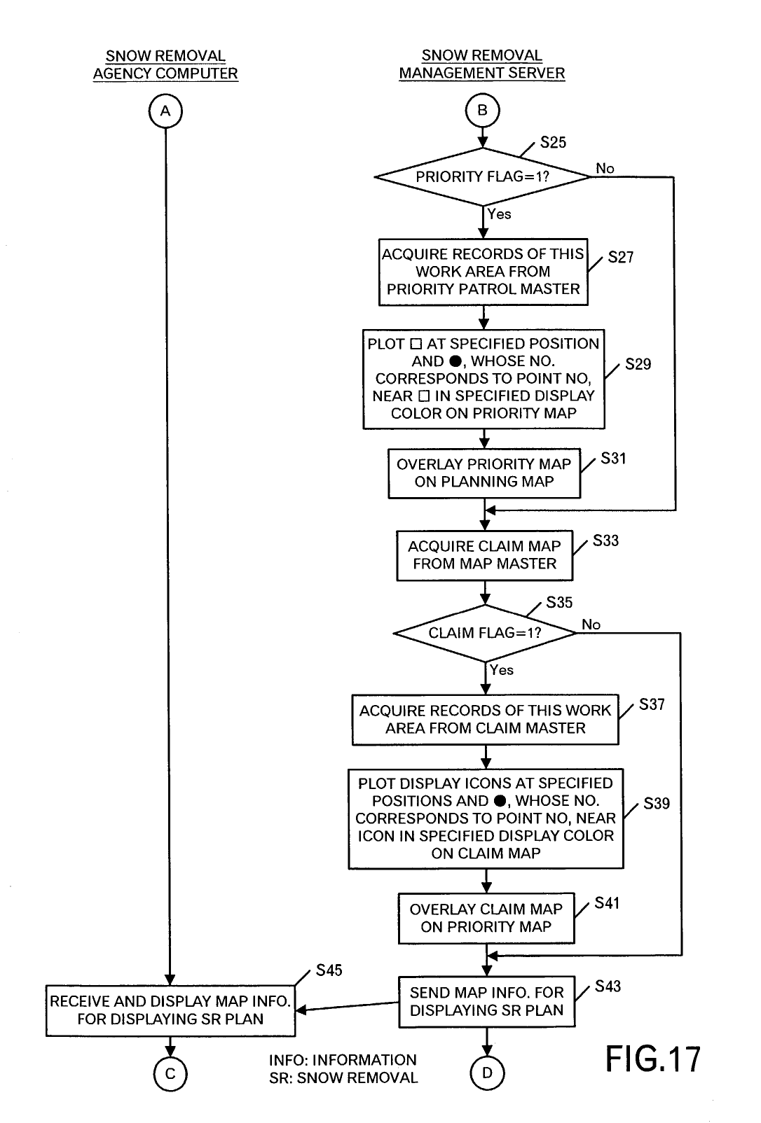

Next, the snow removal planning processor 33 reads out a priority map of the work area, of which the snow removal agency is in charge, from the map master DB 303 (FIG. 4) (step S23). The following processing proceeds to FIG. 17 through terminal A and terminal B. The snow removal planning processor 33 judges whether a priority flag corresponding to the priority map in the map master DB 303 is set to 1 (step S25). This signifies that it is judged whether or not information concerning the priority patrol spot of the work area is registered before this processing. If not registered, the processing proceeds to step S33. If the information concerning the priority patrol spot is registered, the record of the work area is read out from the priority patrol master DB 313 (FIG. 13) (step S27). Then, the specified display icon □ is plotted in the specified display color at the position of the X coordinate and the Y coordinate included in the record of the priority patrol master DB 313, “•”, whose number corresponds to the specified point number, is plotted in the specified display color in the vicinity of the plot of the display icon “□”, and the generated priority map information is stored in the storage device (may be in the map master DB 303) (step S29). Then, the priority map is overlaid on the planning map of the map information generated at the step S21, and they are stored in the storage device (step S31).

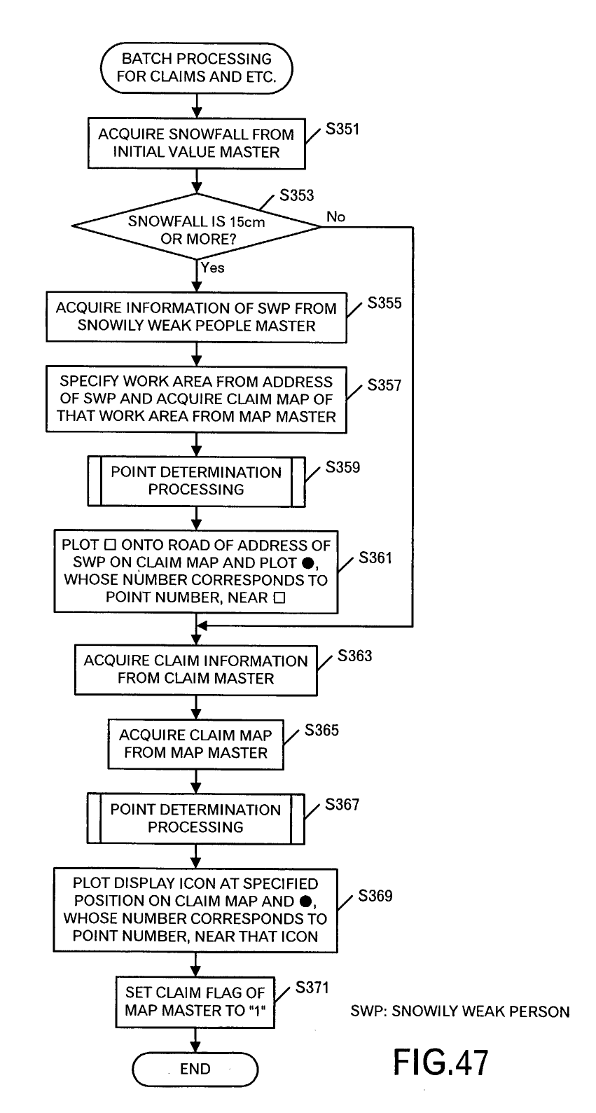

Besides, the snow removal planning processor 33 reads out a claim map of the work area, of which the snow removal agency is in charge, from the map master DB 303 (FIG. 4) (step S33). Then, it is judged whether a claim flag corresponding to the claim map in the map master DB 303 is set to “1” (step S35). This signifies that it is judged whether or not complaint information concerning the work area is registered before this processing. If not registered, the processing proceeds to step S43. If the information concerning the complaint is registered, the record of the work area is read out from the claim master DB 302 (FIG. 3) (step S37) Incidentally, as described in FIG. 47, there is also a case where complaint information is previously plotted on the claim map. Thus, there is also a case where only complaint information added after the execution of the processing of FIG. 47 is subject to the processing, here.

Then, the specified display icon “x (snow clearing)” or “Δ (snow dumping)” is plotted in the specified color at the position of the X coordinate and the Y coordinate included in the record of the claim master DB 302, “•”, whose number corresponds to the specified point number, is plotted in the specified display color in the vicinity of the plot of the display icon “X” or “Δ”, and the generated claim map information is stored in the storage device (may be stored in the map master DB 303) (step S39). Then, the claim map is overlaid on the priority map of the map information generated at the step S31 and they are stored in the storage device (step S41).

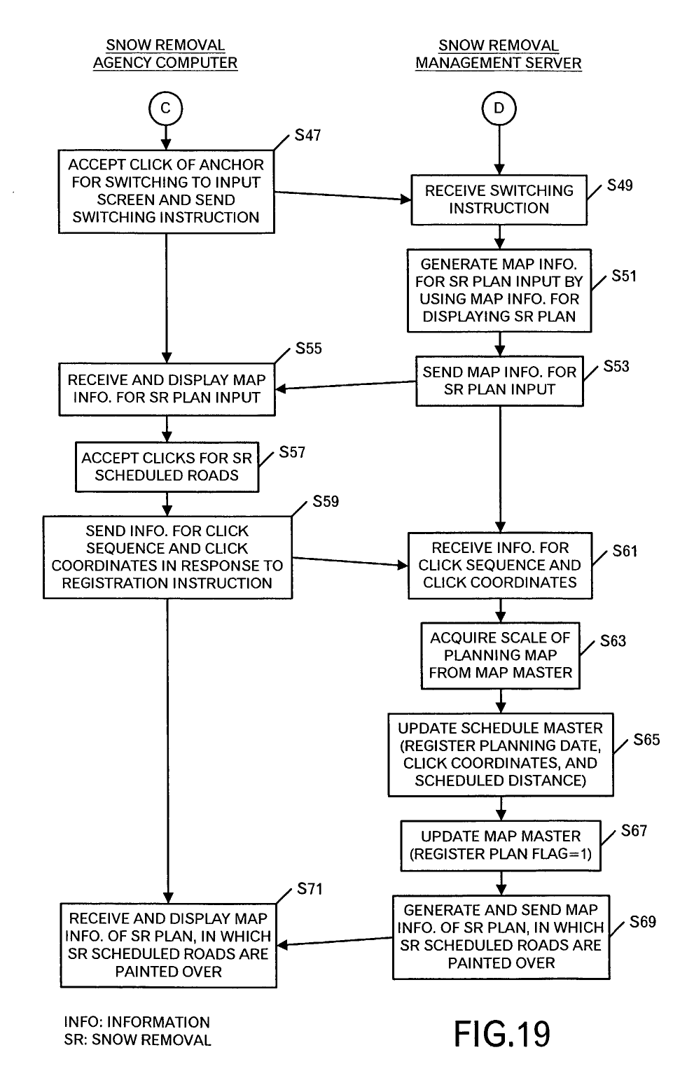

Web page data including map information for displaying the snow removal plan, generated by the above processing is transmitted to the snow removal agency computer 8 as a requester (step S43). The snow removal agency computer 8 receives the Web page data including the map information for displaying the snow removal plan from the snow removal management server 3, and displays it on the display device by the Web browser (step S45). The processing proceeds to FIG. 19 through terminal C and terminal D.

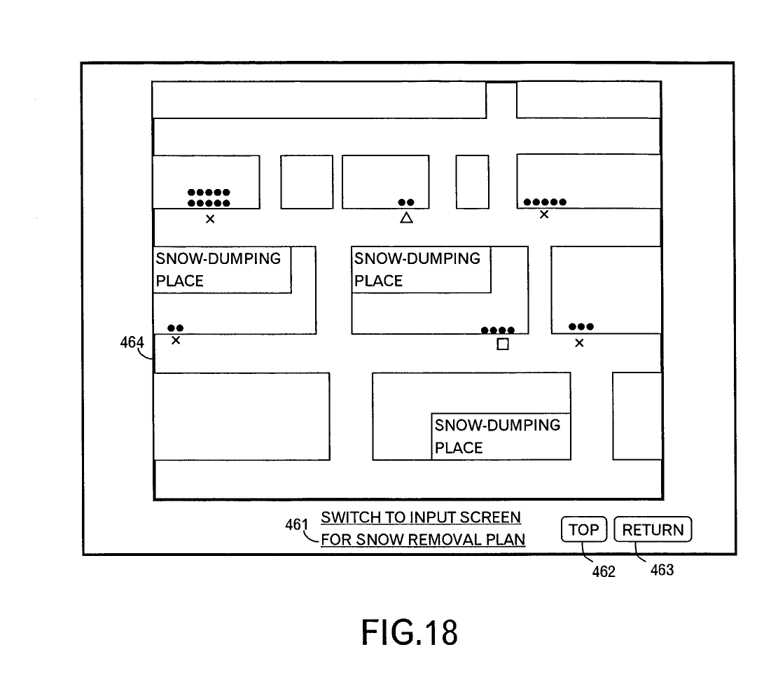

FIG. 18 shows an example of a screen displayed on the display device at the step S45. The example of FIG. 18 includes a map display column 464, a switching anchor 461 to an input screen for the snow removal plan, a button 462 for shifting to a top menu, and a button 463 for returning to the last screen. In the map display column 464 of FIG. 18, four places of snow-clearing complaint (“X”), one place of snow-dumping complaint (“Δ”), and one place of priority patrol spot (“□”) are shown, and the point number of each spot is indicated by “•”.

In the processing of FIG. 19, the person responsible in the snow removal agency, who watches the screen as shown in FIG. 18, refers to the spots indicating the necessity of snow removal, such as Δ, X, and Δ, and clicks the anchor 461 for switching to the input screen for the snow removal plan. The snow removal agency computer 8 accepts the click of the anchor 461, and transmits the instruction of switching to the input screen to the snow removal management server 3 (step S47). When the snow removal planning processor 33 of the snow removal management server 3 receives the instruction of switching to the input screen from the snow removal agency computer 8 (step S49), it generates map information for the snow-removal plan input by using the map information for displaying the snow removal plan and an applet for detecting the clicked coordinates and its sequence on the screen by the person responsible in the snow removal agency (step S51), and transmits Web page data including the map information for the snow-removal plan input to the snow removal agency computer 8 (step S53). The snow removal agency computer 8 receives the Web page data including the map information for the snow-removal plan input from the snow removal management server 3, and displays it on the display device by using the Web browser (step S55).

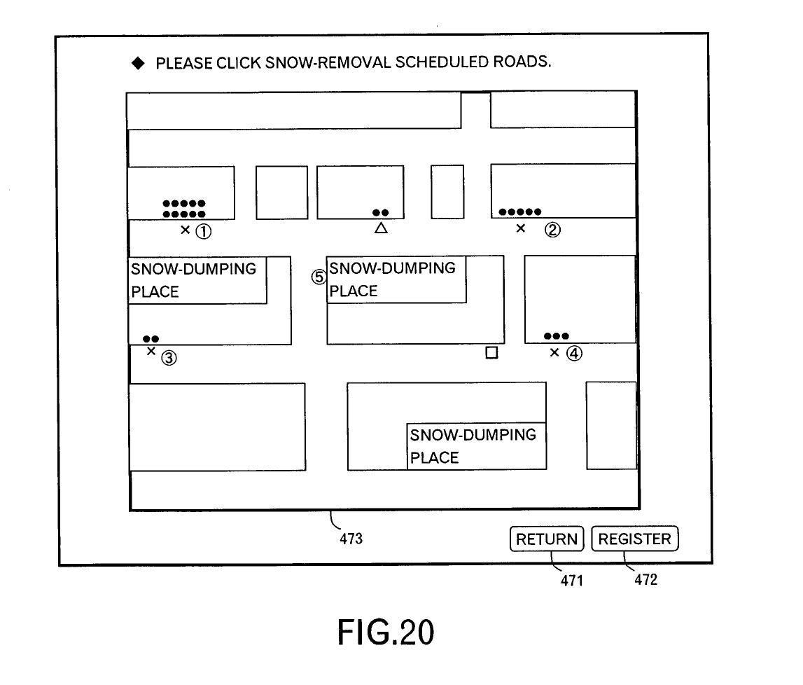

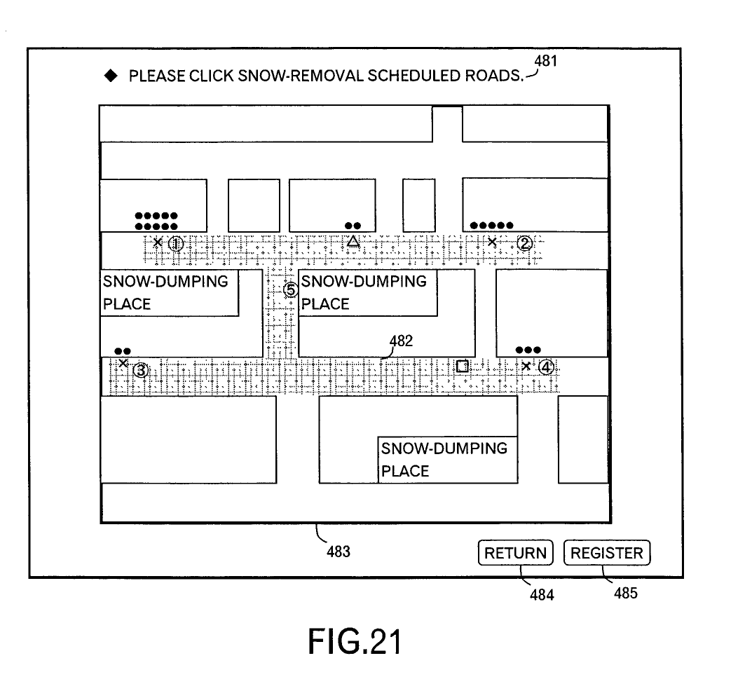

The person responsible in the snow removal agency watches the display of the display device and clicks a start point and an end point of a snow-removal scheduled road in sequence. The applet executed by the snow removal agency computer 8 acquires and holds the click coordinates at every click. Besides, information concerning the click sequence may be displayed at the clicked coordinate position. In that case, for example, a display as shown in FIG. 20 is carried out. In the example of FIG. 20, numerals of 1 to 5 are plotted on a map display column 473. This is information concerning the click sequence. FIG. 20 further includes a button 471 for returning to the last screen and a button 472 for registering the click sequence and the coordinate positions. There is also a case where the snow removal plan determined by the clicks 1 to 5 as shown in FIG. 20 is displayed at this stage. That is, there is also a case where a screen as shown in FIG. 21 is displayed. The example of FIG. 21 includes a message 481 of “Please click snow removal scheduled roads.”, a map display column 483, a button 484 for returning to the last screen, and a button 485 for registering the click sequence and the click position coordinates. In the map display column 483, snow-removal scheduled roads 482 specified by the five clicks are colored and displayed. For example, the applet may carry out such drawing. If doing so, designation confirmation of the snow-removal scheduled road can be made at this stage.

When the person responsible in the snow removal agency clicks the button 472 or 485 for registering, the snow removal agency computer 8 accepts the registration instruction, and transmits the information of the click sequence and the click coordinate positions to the snow removal management server 3 (step S59). When the snow removal planning processor 33 of the snow removal management server 3 receives the information of the click sequence and the click coordinate positions from the snow removal agency computer 8, the snow removal planning processor 33 temporarily stores it in the storage device (step S61). Then, information of the scale of the planning map is read out from the map master DB 303 (FIG. 4) (step S63). Then, the snow-removal scheduled road on the planning map is specified, and further, its length is calculated. The scheduled distance is calculated by the length and scale. The schedule master DB 311 is updated by using the information of the scheduled distance, the planning date, the click sequence and the click coordinate positions (step S65). Then, in the map master DB 303, the plan flag of the planning map is set to “1” (step S67).

Then, as shown in FIG. 20, in the case where the snow removal scheduled road is displayed without being colored, the Web page data including the map information for the snow removal planning in which the snow-removal scheduled road is colored, is generated and is transmitted to the snow removal agency computer 8 (step S69). The generated snow removal planning map in which the snow-removal scheduled road is colored is registered as the planning map in the map master DB 303. In response to this processing, the snow removal agency computer 8 receives the Web page data including the map information for the snow removal planning in which the snow-removal scheduled road is colored, and displays it on the display device by the Web browser (step S71). For example, the screen as shown in FIG. 21 is displayed. However, the message 481 and the registration button 485 are not provided. In the case where this display is a confirmation screen, the registration button 485 is made to remain, and the steps S63 to S67 are not executed, but the steps S63 to S67 may be executed in response to the click of the registration button 485 by the person responsible in the snow removal agency.

By carrying out the above processing, since the person responsible in the snow removal agency can make the snow removal plan while watching the points indicating the necessity of snow removal, it becomes possible to make a plan which is more efficient and raises the satisfaction of citizens. Besides, for the city office, complaints are decreased, and the trouble of reception also disappears. For citizens, if a complaint is registered in a procedure described later, there is a possibility that it is reflected in a snow removal plan, and accordingly, facilities are increased. Incidentally, in the above, it appears that any consideration is not given to the snowily weak people, however, the positions of the snowily weak people are actually replaced by X, Δ, or □ (□ is used in the following explanation) and are displayed. Accordingly, since the person responsible in the snow removal agency can not directly obtain the information of the snowily weak people, there is no fear that it is used for crimes.

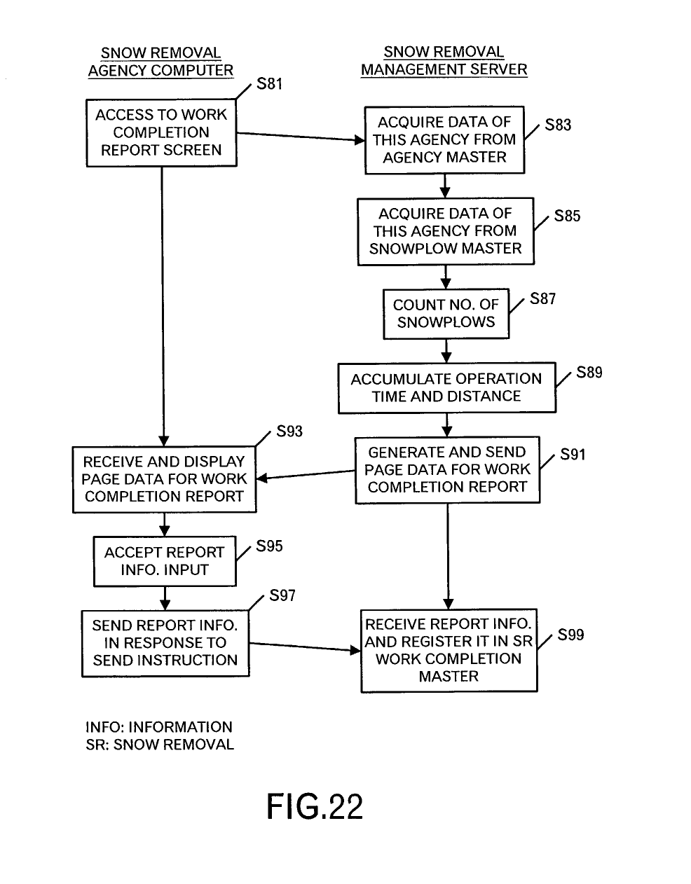

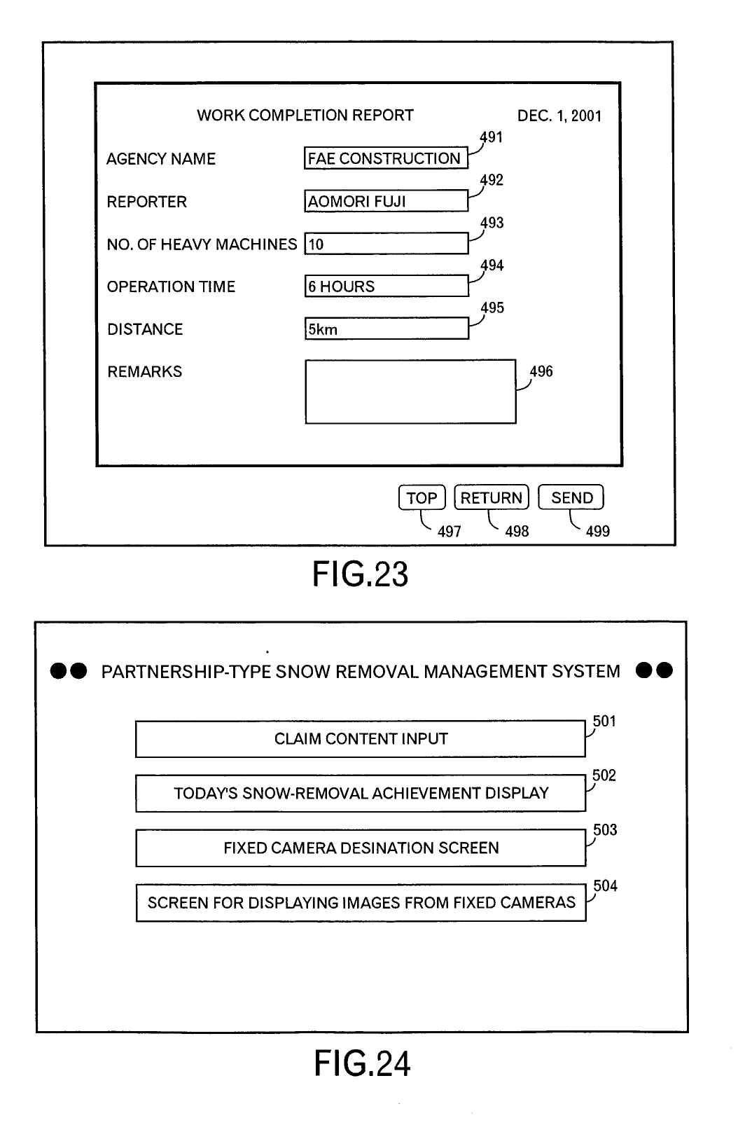

Next, processing in the case where the work completion report screen button 453 of FIG. 14 is clicked by the person responsible in the snow removal agency will be described by the use of FIGS. 22 and 23. In response to the click, the snow removal agency computer 8 accesses a work completion report screen (FIG. 22: step S81). The work completion report processor 35 of the snow removal management server 3 acquires data of the snow removal agency from the agency master DB 307 (FIG. 7) in response to the access (step S83). Incidentally, a name of a previous reporter may be acquired by referring to the snow-removal work completion master DB 301 (FIG. 2). Besides, data of the snow removal agency on the processing date is acquired from the snowplow master DB 309 (FIG. 9) (step S85). The number of snowplows (heavy machines) is counted from the data read out from the snowplow master DB 309 (step S87). Besides, the sum of the operating times and the sum of the distances are calculated (step S89). The work completion report processor 35 generates page data for a work completion report using the data acquired at the steps S83 to S89 and transmits it to the snow removal agency computer 8 (step S91). The snow removal agency computer 8 receives the work completion report page data from the snow removal management server 3, and displays it on the display device by the Web browser (step S93).

FIG. 23 shows a screen example displayed on the display device at the step S93. The example of FIG. 23 shows a format of a work completion report and includes an agency name input column 491, a reporter name input column 492, a heavy machine count input column 493, an operation time input column 494, a distance input column 495, a remark input column 496, a button 497 for returning to a top menu, a button 498 for returning to the last screen, and a button 499 for transmitting a report. Incidentally, with respect to the input columns, the data are previously inputted in the input columns other than the remark input column 496 by the steps S83 to S89. The person responsible in the snow removal agency can correct the previously inputted data, and can make an input to the remark input column 496. When the input and confirmation of the data is ended, the button 499 for transmitting a report is clicked.

The snow removal agency computer 8 transmits the information of the work completion report to the snow removal management server 3 in response to the transmission instruction of the person responsible in the snow removal agency (step S97). The work completion report processor 35 of the snow removal management server 3 receives the information of the work completion report from the snow removal agency computer 8, and registers it in the snow-removal work completion master DB 301 (FIG. 2) (step S99). Incidentally, at this time, a mail of the same content may be separately transmitted to the person responsible in the city office.

By carrying out such processing, the preparation of the work completion report by the snow removal agency becomes efficient, and the confirmation and use of the report in the city office becomes efficient.

Since processing in the case where the snow-removal agency achievement screen button 452 is clicked on the menu screen for the snow removal agency shown in FIG. 14 is almost the same as processing in the case where a request is made by the city office, it will be described later.

Next, processing in the case where a general citizen uses the citizen computer 7 to access the snow removal management server 3 will be described by the use of FIGS. 24 to 34. The citizen operates the citizen computer 7 to access the snow removal management server 3, and the citizen computer 7 displays a main menu for citizens on the basis of Web page data received from the snow removal management server 3, which is shown in FIG. 24. Incidentally, user registration may be indispensable for a citizen as well, and a login processing may be executed before the screen of FIG. 24 is displayed. The example of FIG. 24 includes a claim content input button 501, a today's snow-removal achievement display button 502, a fixed camera designation screen button 503, and a button 504 for a screen for displaying images from fixed cameras.

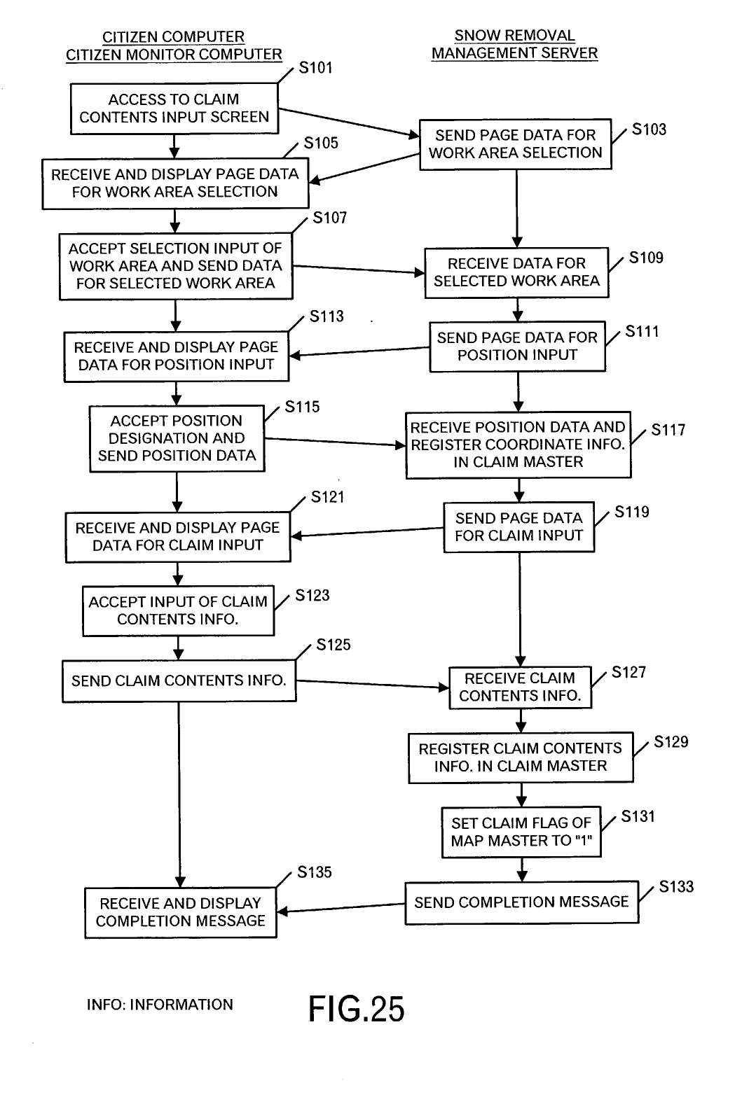

First, processing in the case where the claim content input button 501 is clicked will be described by the use of FIGS. 25 to 28. When the claim content input button 501 is clicked by a citizen, the citizen computer 7 accesses a claim content input screen (step S101). In response to the access, the claim related processor 31 of the snow removal management server 3 transmits work area selection page data to the citizen computer 7 (step S103). The citizen computer 7 receives the work area selection page data from the snow removal management server 3, and displays it on the display device by the Web browser (step S105).

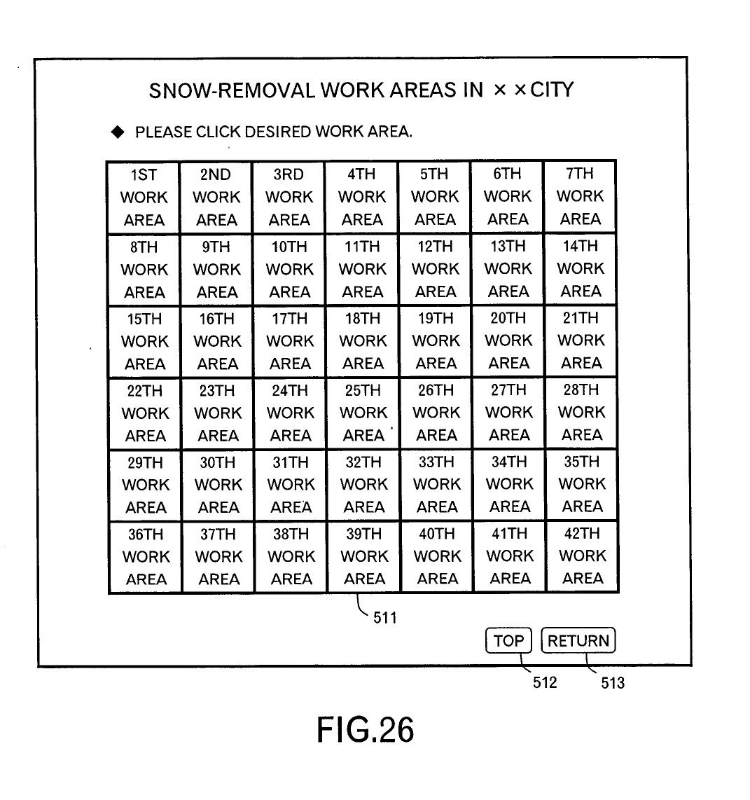

FIG. 26 shows a screen example of a work area selection page. The example of FIG. 26 includes a button group 511 for selecting any one of work areas 1 to 36, a button 512 for returning to a top menu, and a button 513 for returning to the last screen. Incidentally, when there is no information other than this information, only a person familiar with the division of the work areas can select the work area. Thus, an address or the like may be displayed under the name of the work area. Besides, not the screen for selecting the work area, but a screen for inputting an address may be adopted. In the case of the screen for inputting the address, the snow removal management server 3 has to carry out the processing for specifying the work area from the address.

The citizen watches the display as shown in FIG. 26 and clicks the work area where he or she lives or a complaint occurs. In response to this, the citizen computer 7 accepts the work area selection input, and transmits information of the selected work area to the snow removal management server 3 (step S107). The claim related processor 31 of the snow removal management server 3 receives the information of the selected work area, reads out the basic map of the selected work area from the map master DB 303 (FIG. 4), generates position input page data, and transmits it to the citizen computer 7 (step Sill). The citizen computer 7 receives the position input page data from the snow removal management server 3, and displays it on the display device by the Web browser (step S113).

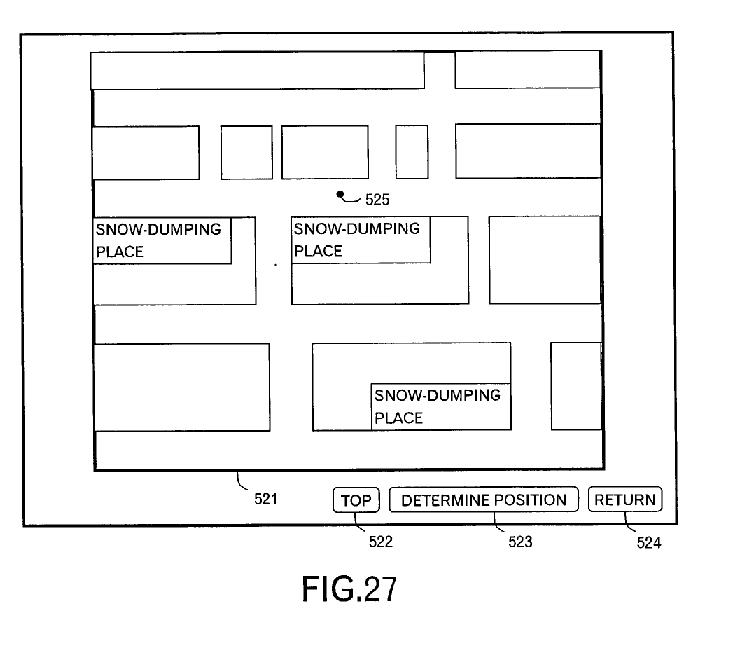

FIG. 27 shows a screen example of a position input page. The example of FIG. 27 includes a column 521 to display a map for position input, a button 522 for returning to a top menu, a button 523 for notifying the snow removal management server 3 of the determination of the position, and a button 524 for returning to the last screen. In the column 521 to display a map for the position input, when the position at which the complaint occurs is clicked, for example, an applet plots a point 525 at the clicked position, and acquires position coordinates. Then, when the citizen clicks the button 523 for notifying the determination of the position, the information of the position coordinates is transmitted to the snow removal management server 3. Incidentally, an applet may give a warning with respect to unsuitable position designation.

As stated above, the citizen computer 7 accepts the position designation by the citizen, and transmits it to the snow removal management server 3 (step S115). When the snow removal management server 3 receives the position designation from the citizen computer 7, it registers information regarding the position coordinates as a new record of the claim master DB 302 (FIG. 3) (step S117). Incidentally, the information may be not registered in the claim master DB 302 at the step S117, but it may be temporarily stored in the storage device and registered later. Besides, since the snow removal by a heavy machine can be made only on a road having a certain degree of width, in case the instructed position coordinates indicate a road where the snow removal by the heavy machine can not be made, a message to that effect may be transmitted to the citizen computer 7. Then, the claim related processor 31 transmits claim input page data to the citizen computer 7 (step S119). The citizen computer 7 receives the claim input page data from the snow removal management server 3, and displays it on the display device by the Web browser (step S121).

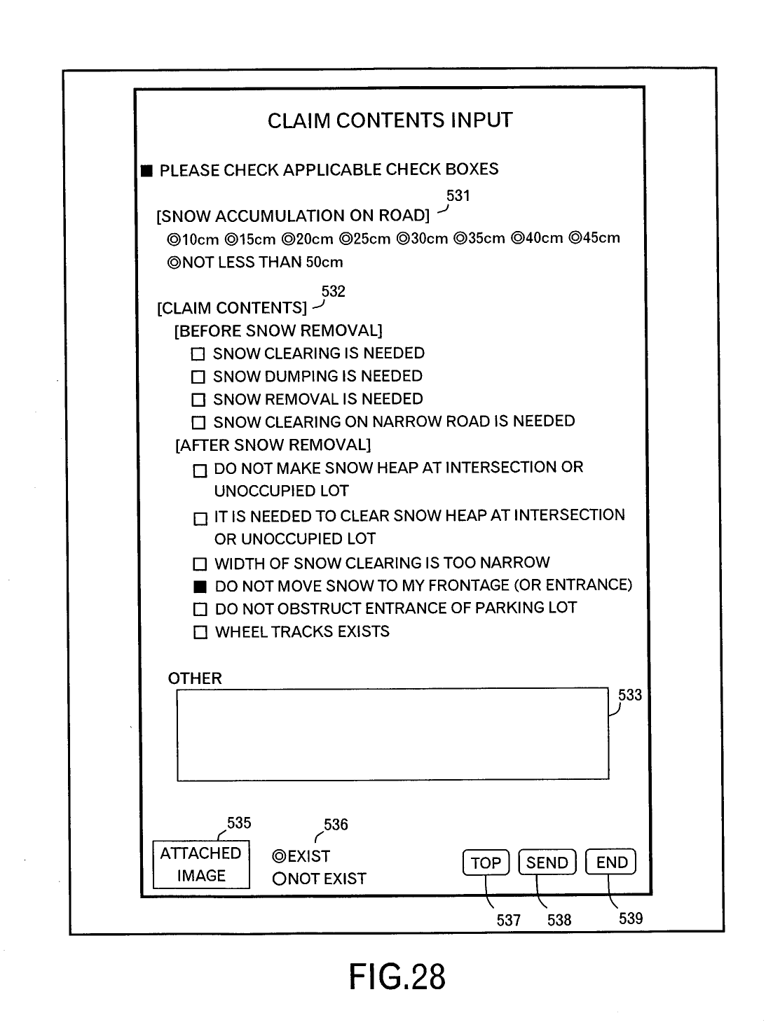

FIG. 28 shows a screen example of the claim input page. The example of FIG. 28 includes a selection part 531 of snow accumulations on the roads, a claim content selection part 532, an input column 533 of other complaints, an attaching image specification button 535, a radio button 536 for specifying the existence of an attached image, a button 537 for returning to a top menu, a button 538 for transmitting inputted information, and a button 539 for terminating the processing. The citizen selects the snow accumulation on the road, and selects the pertinent complaint content. The other complaints are inputted to the input column 533. In a case where there is an attaching image, the attached image button 535 is clicked so that a file can be selected.

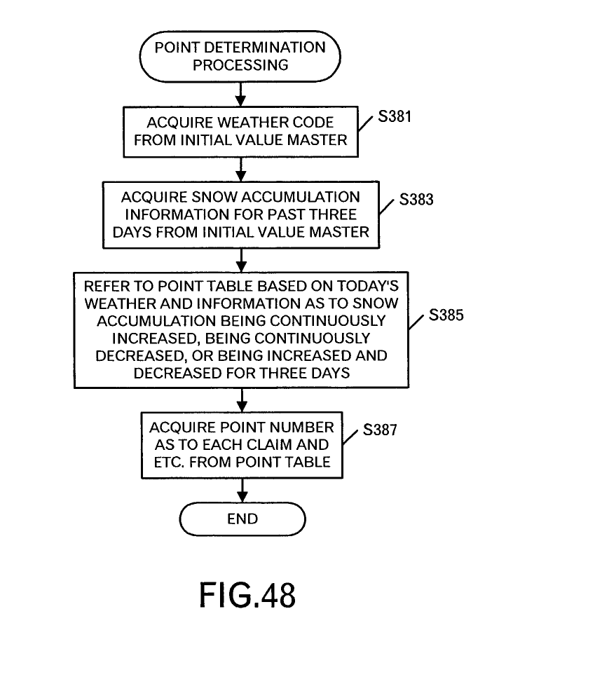

When the input in FIG. 28 is completed, the citizen clicks the button 538. The citizen computer 7 accepts the inputted claim content information, and transmits the claim content information to the snow removal management server 3 in accordance with the transmission instruction (step S125). In case an attached image file is specified, the file is also transmitted. When the claim related processor 31 of the snow removal management server 3 receives the claim content information from the citizen computer 7 (step S127), the claim related processor 31 registers it in the claim master DB 302 (FIG. 3) (step S129). Incidentally, the display icon is registered as “X” in the case where the claim classification is snow clearing, and the display icon is registered as “Δ” in the case of snow dumping. Besides, at this stage, a point determination processing (FIG. 48) described below is executed, and the point number and the display color may be registered in the claim master DB 302 (FIG. 3).

Further, in the table of the processing date in the map master DB 303 (FIG. 4), the claim flag of the claim map in the work area is set to “1” (step S131). When the above registration processing is completed, a completion message such as “Normally registered” is transmitted to the citizen computer 7 (step S133). The citizen computer 7 receives the completion message from the snow removal management server 3, and displays it on the display device (step S135). Incidentally, in the case where some error occurs, the registration is not made, and an error message such as “Registration could not be made. Please again register.” is transmitted.

By carrying out the processing as stated above, the citizen can register the complaint concerning the snow removal, and can make it referred by the snow removal agency or the like at the time of snow removal planning.

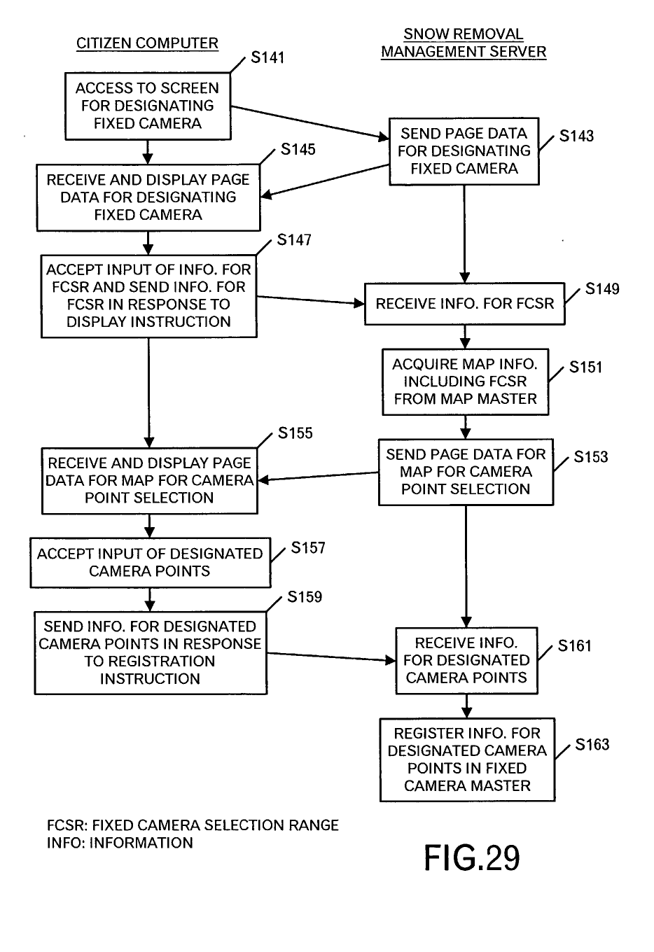

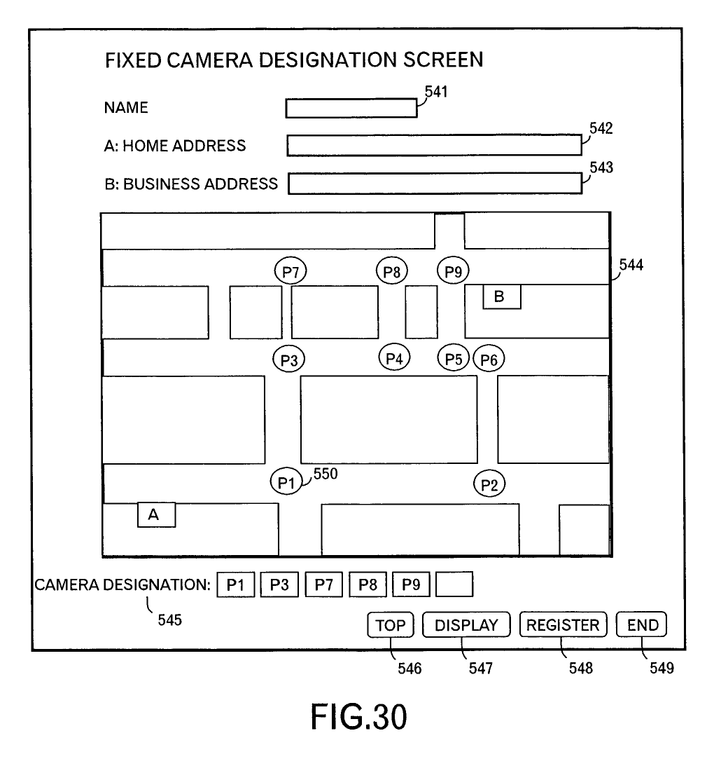

Next, processing in the case where the fixed camera designation screen button 503 is clicked on the menu for citizens of FIG. 24 will be described by the use of FIGS. 29 and 30. When the citizen clicks the fixed camera designation screen button 503, the citizen computer 7 accesses a fixed camera designation screen (step S141). The snow removal management server 3 transmits fixed camera designation page data to the citizen computer 7 in response to the access (step S143). The citizen computer 7 receives the fixed camera designation page data, and displays it on the display device by the Web browser (step S145).

A screen example of the fixed camera designation page will be described by the use of FIG. 30. The example of FIG. 30 includes a name input column 541, a home address input column 542, a business address input column 543, a column 544 to display a map for fixed camera selection, a camera designation input column 545, a button 546 for shifting to a top menu screen, a button 547 for causing to display a map for a fixed camera selection, a button 548 for registration of selected fixed camera, and a button 549 for terminating the processing. Incidentally, at the stage of the step S145, since it is not clear that a map of what area should be displayed, the column 544 to display a map for fixed camera selection and the like are not displayed. The citizen inputs the name, the home address, and the business address into the respective input columns and clicks the display button 547.

The citizen computer 7 accepts the information concerning the fixed camera selection range specified by the home address and the business address inputted by the citizen, and transmits the information concerning the fixed camera selection range to the snow removal management server 3 in response to the display instruction by the citizen (step S147). The fixed camera image processor 32 of the snow removal management server 3 receives the information concerning the fixed camera selection range from the citizen computer 7 (step S149), and registers it in the fixed camera master DB 312 (FIG. 12). Then, it reads out map information including the selection range specified by the home address and the business address from the map master DB 303 (step S151). Although not shown, the map information for fixed camera selection is stored in the map master DB 303 separately from FIG. 4. Then, the coordinate positions corresponding to the home address and the business address are determined and are plotted on the read map. The information of the coordinate positions is also stored in the fixed camera master DB 312. Then, it generates page data for a map for camera point selection using this map information, and transmits the page data to the citizen computer 7 (step S153). The citizen computer 7 receives the page data for a map for the camera point selection from the snow removal management server 3, and displays it on the display device by the Web browser (step S155). At this stage, the screen as shown in FIG. 30 is displayed. The positions of fixed cameras, together with camera names, are displayed at, for example, a point 550 and etc.

The citizen selects one or plural fixed cameras from among, for example, fixed cameras P1 to P9 positioned from a home A to a business place B, and inputs them in the camera designation input column 545. Then, the button 548 for registration is clicked. Alternatively, a structure may be such that the point 550 of the fixed camera may be a button, and when it is clicked, the fixed camera name may be automatically inputted in the camera designation input column 545.

The citizen computer 7 accepts the input of the designated camera point, and transmits the designated camera point information inputted in the camera designation input column 545 to the snow removal management server 3 in response to the registration instruction (step S159). When the fixed camera image processor 32 of the snow removal management server 3 receives the designated camera point information from the citizen computer 7, it stores the received information in the fixed camera master DB 312 (FIG. 12) (step S163).

By carrying out the processing as stated above, the fixed camera image described below can be easily acquired.

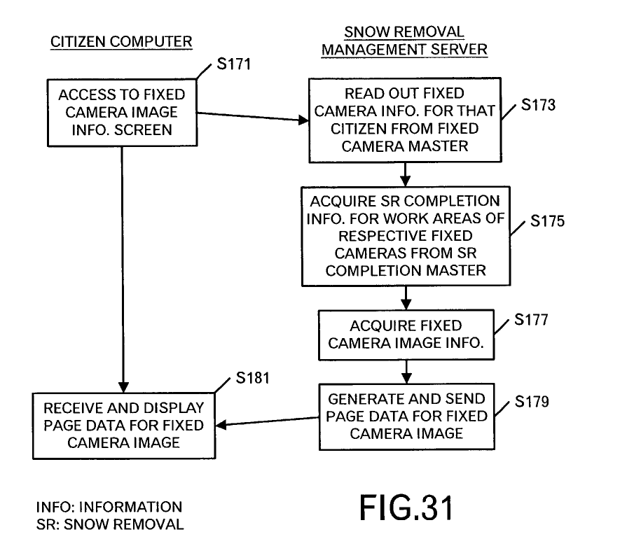

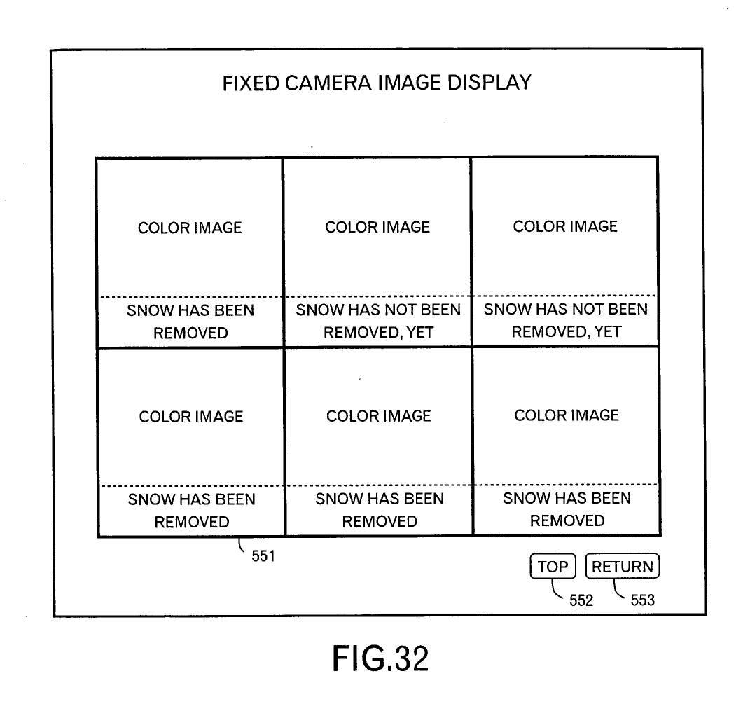

Next, processing in the case where the button 504 for a screen for displaying fixed camera image is clicked on the menu for citizens of FIG. 24 will be described by the use of FIGS. 31 and 32. When the button 504 for a screen for display images is clicked, the citizen computer 7 accesses a fixed camera image information screen (step S171). In response to the access, the fixed camera image processor 32 of the snow removal management server 3 reads out the fixed camera information about the citizen from the fixed camera master DB 312 (FIG. 12) (step S173). Incidentally, in the case where a login processing was not carried out first, for example, input of information for identifying the citizen is requested at this time, and after citizen identification information is acquired from the citizen computer 7, the step S173 is carried out.

Then, snow removal completion information concerning the work area where the respective fixed cameras included in the fixed camera information are installed, is read out from the snow removal completion master DB 301 (FIG. 2) (step S175). This processing is such a processing that the work area corresponding to the fixed camera is specified on the basis of a corresponding table of fixed cameras and work areas, and it is confirmed whether or not the report date of the work completion report concerning the work area of each fixed camera is registered on the processing date or the date of the previous day. Then, the fixed camera image processor 32 reads out the fixed camera image information from the fixed camera image storage 305, and forms fixed camera image page data, and transmits it to the citizen computer 7 (step S179). The citizen computer 7 receives the fixed camera image page data from the snow removal management server 3, and displays it on the display device by the Web browser (step S181).

FIG. 32 shows a screen example of the fixed camera image page. The example of FIG. 32 includes a column 551 for displaying a fixed camera image and completion or non-completion of snow removal, a button 552 for returning to a top page, and a button 553 for returning to the last screen. Here, although images of six places are displayed, the number is arbitrary.

By such processing, the citizen can grasp the state from the home to the place of business (or place of commute).

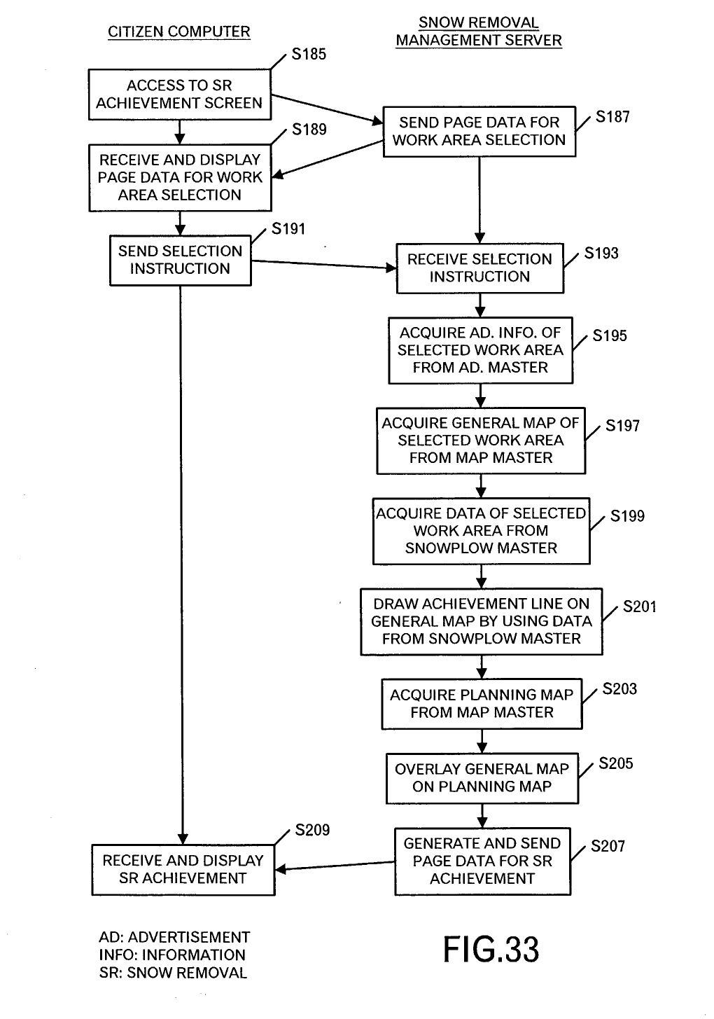

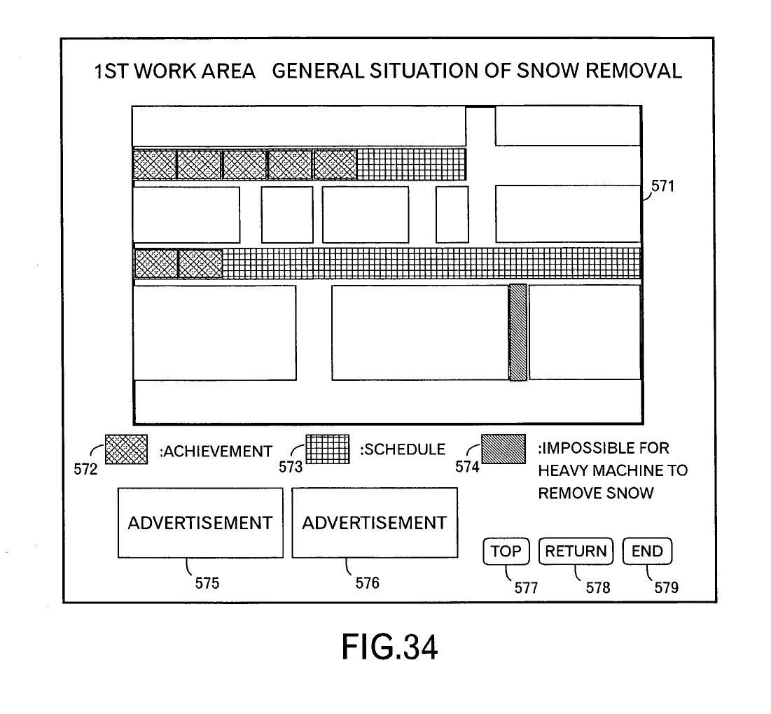

Processing in the case where the today's snow-removal achievement display button 502 is clicked on the menu for citizens of FIG. 24 will be described by the use of FIGS. 33 and 34. When the button 502 is clicked, the citizen computer 7 accesses a snow-removal achievement screen (step S185). The snow-removal achievement data processor 34 of the snow removal management server 3 transmits work area selection page data to the citizen computer 7 in response to the access (step S187). The citizen computer 7 receives the work area selection page data from the snow removal management server 3, and displays it on the display device by the Web browser (step S189). For example, the screen as shown in FIG. 26 is displayed.

The citizen selects a work area in which confirmation of snow-removal work achievement is desired, and clicks it. The citizen computer 7 transmits the selection instruction of the work area by the click to the snow removal management server 3 (step S191). The snow-removal achievement data processor 34 of the snow removal management server 3 receives the selection instruction of the work area from the citizen computer 7 (step S193), and reads out advertisement information of the selected work area from the advertisement master DB 304 (FIG. 5) (step S195). Besides, a general map of the selected work area is read out from the map master DB 303 (FIG. 4) (step S197), and data of the selected work area is read out from the snowplow master DB 309 (FIG. 9) (step S199). Then, the snow-removal achievement data processor 34 draws an achievement line on the general map by using the data from the snowplow master DB, and stores it in the storage device (step S201). That is, the achievement line is drawn from the starting point X coordinate and the starting point Y coordinate to the end point X coordinate and the end point Y coordinate with consideration of the road information. Incidentally, in the case where plural heavy machines are operated in the same work area, plural achievement lines are drawn.

Then, the snow-removal achievement data processor 34 reads out a planning map from the map master DB 303 (FIG. 4) (step S203), overlays the general map on which the achievement line was drawn at the step S201 on the read planning map, and stores it in the storage device (step S205). Incidentally, at this stage, there is also a case where a scheduled line of the snow removal is drawn using the data registered in the schedule master DB 311. Finally, it generates snow-removal achievement page data by using the generated map information, and transmits it to the citizen computer 7 (step S207). The citizen computer 7 receives the snow-removal achievement page data from the snow removal management server 3, and displays it on the display device by the Web browser (step S209).

FIG. 34 shows a screen example of the snow-removal achievement page displayed at the step S209. The example of FIG. 34 includes a snow-removal general state display column 571, a hatching display example 572 of a snow-removal achievement portion, a hatching display example 573 of a snow removal scheduled portion, a hatching display example 574 of a portion impossible for a heavy machine to remove snow, a first advertisement column 575, a second advertisement column 576, a button 577 for shifting to a top menu, a button 578 for returning to the last screen, and a button 589 for terminating the processing. By such display, the citizen can grasp the snow removal schedule and the degree of the snow removal, which has been carried out up to now.

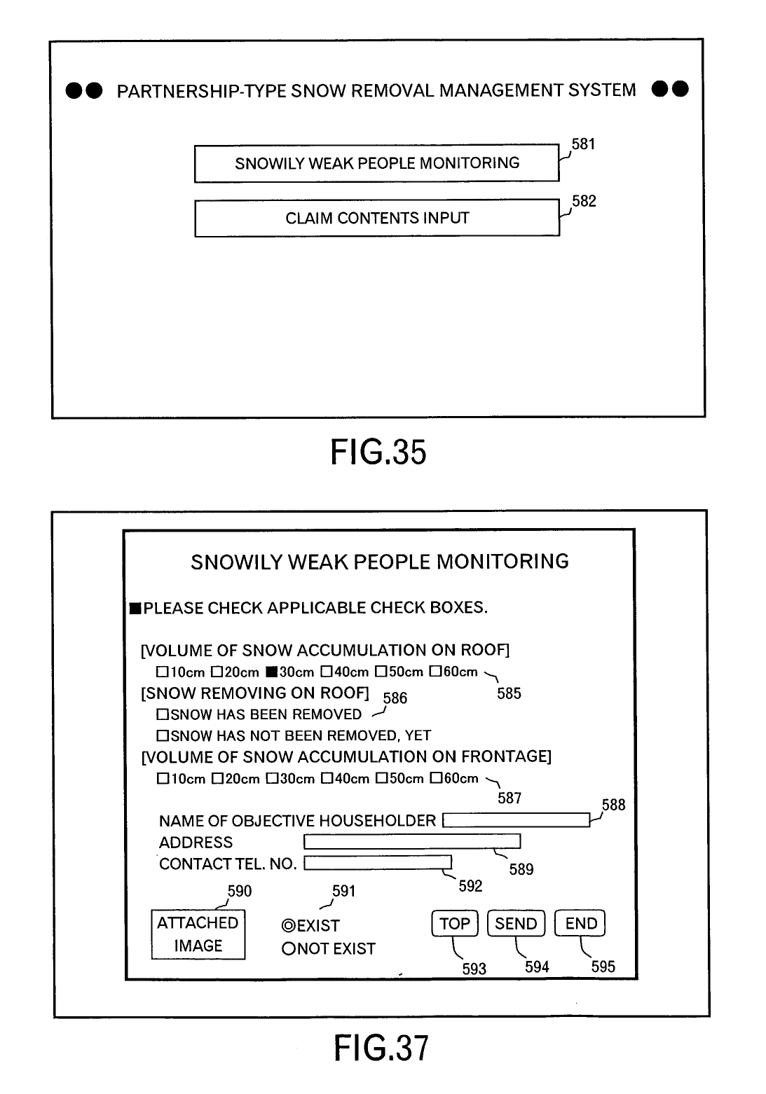

Next, processing at the time when a citizen monitor (for example, a welfare commissioner or a head of town council) accesses the snow removal management server 3 will be described by the use of FIGS. 35 to 37. The citizen monitor operates the citizen monitor computer 5 to access the snow removal management server 3, and after the snow removal management server 3 carries out an authentication processing to identify the citizen monitor, information is sent to the citizen monitor computer 5, and the citizen monitor computer 5 displays a screen, an example of which is shown in FIG. 35. The example of FIG. 35 includes a snowily weak person monitoring button 581, and a claim content input button 582. The claim content input button 582 is equivalent to the claim content input button 501 of the menu screen for citizens (FIG. 24).

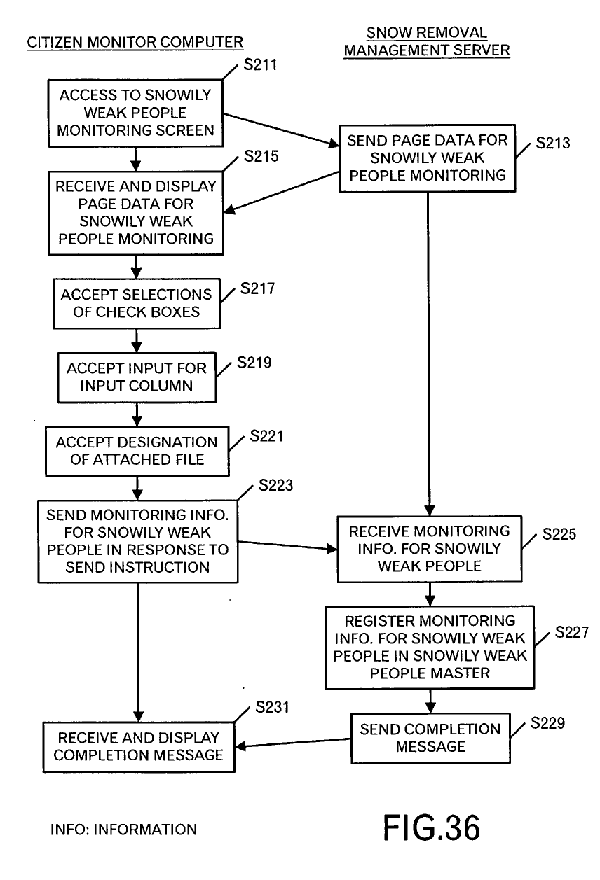

Here, processing in the case where the snowily weak person monitoring button 581 is clicked by the citizen monitor will be described by the use of FIGS. 36 and 37. When the snowily weak person monitoring button 581 is clicked by the citizen monitor, the citizen monitor computer 5 accesses a snowily weak person monitoring screen (step S211). The claim related processor 31 of the snow removal management server 3 transmits page data for snowily weak person monitoring to the citizen monitor computer 5 in response to the access (step S213). The citizen monitor computer 5 receives the page data for the snowily weak person monitoring and displays it on the display device by the Web browser (step S215).

FIG. 37 shows a screen example of the snowily weak person monitoring page. The example of FIG. 37 includes a column 585 for selecting the roof-covering snow accumulation, a column 586 for selecting completion or non-completion of the roof-covering snow removing, a column 587 for selecting the frontage snow accumulation, an input column 588 of an objective householder name of a snowily weak person, an input column 588 of an address of a snowily weak person, an input column 592 of a contact telephone number, a button 590 for specifying a file in the case where there is an attached image file, a radio button 591 for specifying the existence of an attached image, a button 593 for returning to a top menu, a transmission button 594 for transmitting input information, and an end button 595 for ending the processing. The citizen monitor selects the roof-covering snow accumulation of the house of the snowily weak person, selects whether or not the roof-covering snow removing has been made, selects the frontage snow accumulation, inputs the name of the snowily weak person, the address, and the telephone number, and clicks the transmission button 594.

The citizen monitor computer 5 accepts the selection of the check boxes (step S217), and accepts the input information to the input columns (step S219). Besides, in the case where there is an attached image file, the specification of the attached file is accepted (step S221). Then, in response to the transmission instruction by the citizen monitor, the inputted monitoring information of the snowily weak person (including the attached image file in the case where it is specified) is transmitted to the snow removal management server 3 (step S223). The claim related processor 31 of the snow removal management server 3 receives the monitoring information of the snowily weak person from the citizen monitor computer 5 (step S225), and registers the monitoring information of the snowily weak person in the snowily weak person master DB 308 (FIG. 8) (step S227). The snowily weak person master DB 308 is searched using the name of the snowily weak person, for example, and the address, and the roof-covering snow accumulation, the frontage snow accumulation, the attached image file and the like are registered. When the registration is completed, the claim related processor 31 transmits a completion message to the effect that the processing is normally ended to the citizen monitor computer 5 (step S229). The citizen monitor computer 5 receives the completion message from the snow removal management server 3, and displays it on the display device (step S231).

As described later, by carrying out the registration as set forth above, a notice of the state of the snowily weak person can be given to the city office through the snow removal management server 3, and the expression form such as a complaint or a priority patrol spot is adopted so that it is also possible to notify the snow removal agency of the necessity of snow removal without specifying the snowily weak person. Incidentally, even if the snow removal can not be made by the snow removal agency, it becomes possible to notify, for example, volunteers. That is, it becomes easy to obtain cooperation in the region.

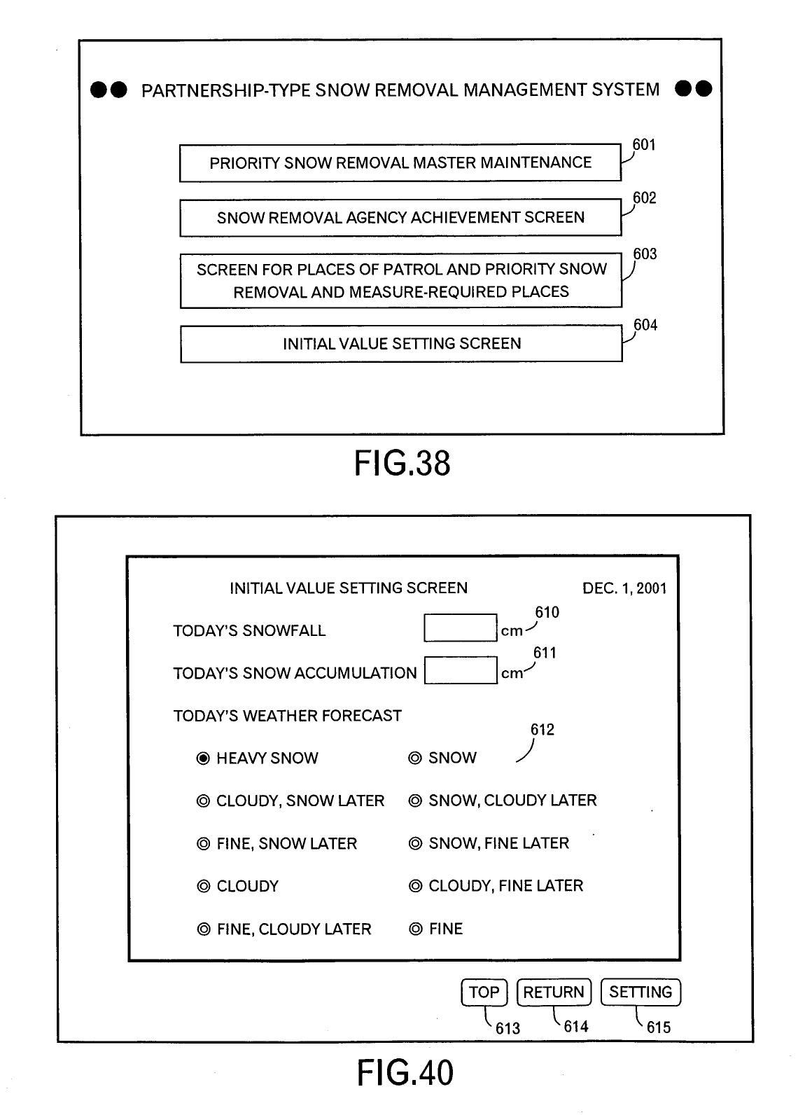

Next, processing when the person responsible in the city office operates the city office computer 6 to access the snow removal management server 3 will be described by the use of FIGS. 38 to 46. The person responsible in the city office operates the city office computer 6 to access the snow removal management server 3, and after an authentication processing is carried out by the snow removal management server 3, a menu screen for a city office, an example of which is shown in FIG. 38, is transmitted from the snow removal management server 3 and is displayed by the city office computer 6. The example of FIG. 38 includes a priority master maintenance button 601, a button 602 for displaying a screen for the achievement of the snow removal agency, a button 603 for displaying a screen for displaying a screen to indicate places of patrol and priority snow removal and measure-required places, and a button 604 for displaying a screen for initial value setting.

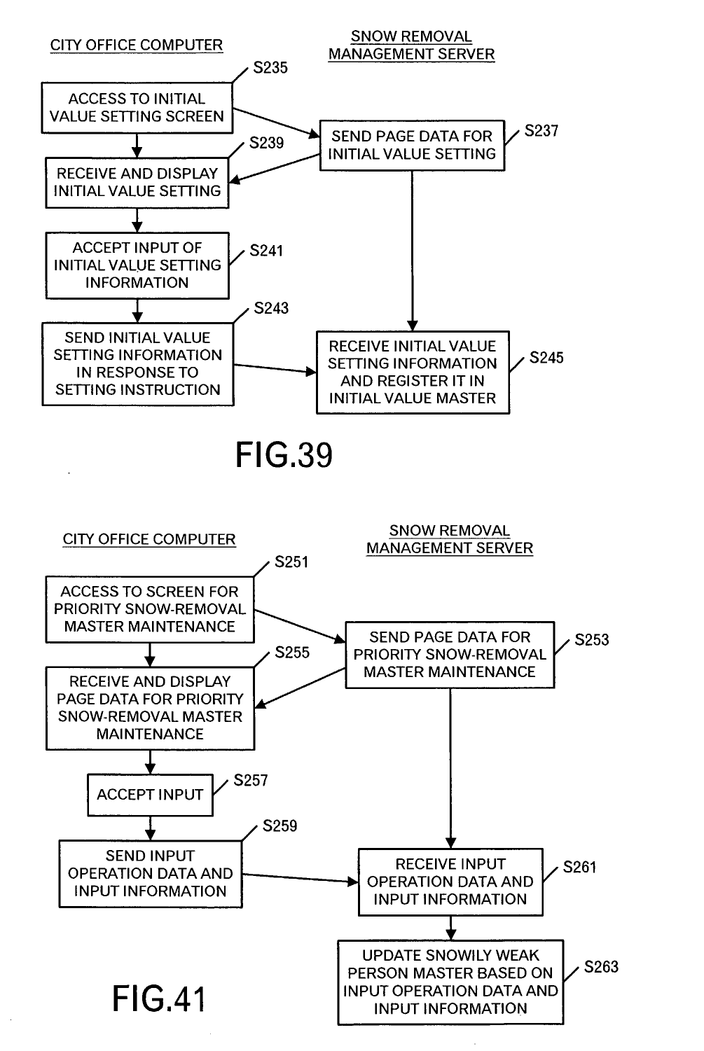

First, processing in the case where the button 604 for displaying a screen for initial value settings is clicked will be described by the use of FIGS. 39 and 40. When the button 604 for initial value settings is clicked, the city office computer 6 accesses an initial value setting screen (step S235). The city office maintenance processor 36 of the snow removal management server 3 transmits page data for initial value settings to the city office computer 6 (step S237). The city office computer 6 receives the page data for the initial value settings, and displays it on the display device by the Web browser (step S239).

FIG. 40 shows a screen example of the initial value setting page. The example of FIG. 40 includes an input column 610 of today's snowfall, an input column 611 of today's snow accumulation, a selection column 612 of today's weather forecast, a button 613 for returning to a top menu, a button 614 for returning to the previous screen, and a setting button 615 for setting inputted initial values. The person responsible in the city office inputs information of the snow accumulation, the snowfall, and the weather.

The city office computer 6 accepts the input of such initial value setting information (step S241), and transmits the information of the initial value settings to the snow removal management server 3 in response to the setting instruction by the click of the setting button 613 (step S243). The city office maintenance processor 36 of the snow removal management server 3 receives the information of the initial value settings from the city office computer 6, and registers it in the initial value master DB 306 (FIG. 6) (step S245).

The information of the initial value settings registered in this way is used for subsequent processing.

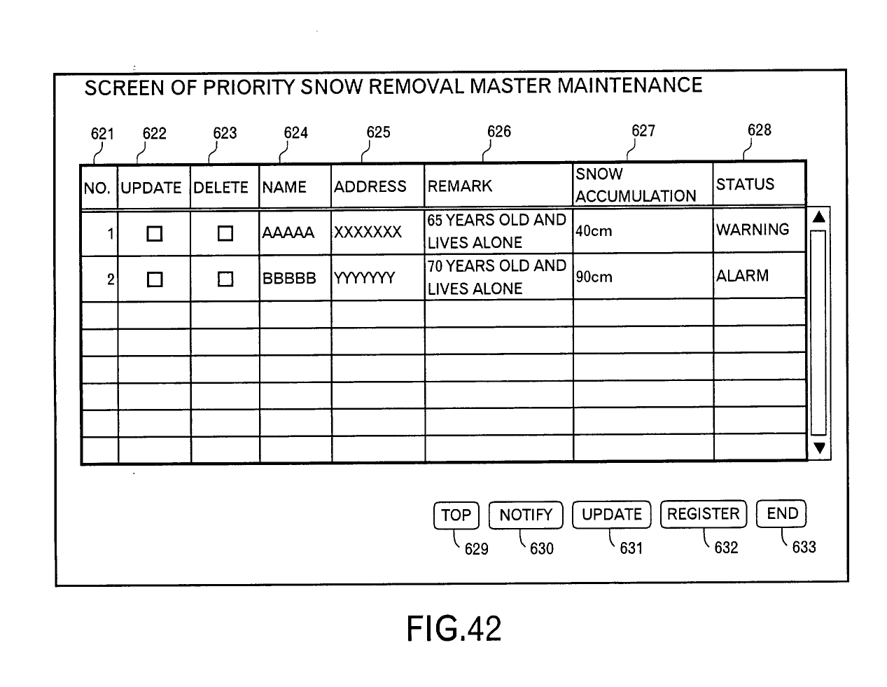

Next, processing in the case where the priority snow removal master maintenance button 601 is clicked on the menu for the city office of FIG. 38 will be described by the use of FIGS. 41 and 42. First, in response to the click of the priority snow removal master maintenance button 601, the city office computer 6 accesses a priority snow removal master maintenance screen (step S251). In response to the access, the city office maintenance processor 36 of the snow removal management server 3 generates page data for priority snow removal master maintenance from the data stored in the snowily weak person master DB 308 (FIG. 8), and transmits it to the city office computer 6 (step S253). The city office computer 6 receives the page data for the priority snow removal master maintenance from the snow removal management server 3, and displays it on the display device by the Web browser (step S255).

FIG. 42 shows a screen example of the priority snow removal master maintenance page. The example of FIG. 42 includes a table containing a column 621 of a priority number, a column 622 of a renewal check, a column 623 of a delete check, a column 624 of a name, a column 625 of an address, a column 626 of a remark, a column 627 of a snow accumulation, and a column 628 of a status, a button 629 for shifting to a top menu, a button 630 for notifying volunteers, a button 631 for data renewal, a button 632 for new registration, and a button 633 for ending the processing. Although not shown, other information of the snowily weak people may be displayed, edited, and inputted. In the case where information of a snowily weak person is newly registered, the person responsible in the city office inputs information in a blank row, and clicks the button 632 for new registration. In the case where information already inputted is edited, a check is given to the renewal check box, correction content is inputted, and the button 631 for data renewal is clicked. In the case where the information of a snowily weak person is deleted, a check is given to a deletion check box, and the button 632 for registration is clicked. The column 628 of the status expresses the state of the roof-covering snow accumulation, and for example, when it is 50 cm or more, an alarm is displayed, and when it is less than 50 cm, a warning is displayed. In the case where the snow clearing work is requested to the volunteer, the citizen monitor, or other previously registered people, the button 630 for notification is clicked. In the case where the button 630 for notification is clicked, a mail is transmitted from the snow removal management server 3 to, for example, the volunteer in charge of each snowily weak person. In case data input is made by the citizen monitor, the information such as the snow accumulation is updated.

The city office computer 6 accepts the operation instruction and the input information by the person responsible in the city office, and transmits the operation instruction information and the input information to the snow removal management server 3 (step S259). The city office maintenance processor 36 of the snow removal management server 3 receives the operation instruction information and the input information from the city office computer 6 (step S261), and updates the snowily weak person master DB 308 (FIG. 8) on the basis of the operation instruction information and the input information (step S263). The registration of the new input information, the registration of the correction information, and the deletion of the registration information are carried out. Besides, in the case where notification is instructed, a mail may be sent as described above.

In addition to the processing of FIGS. 41 and 42, it is also necessary to maintain the data concerning the priority patrol spots. At that time, for example, the data of the priority patrol master DB 313 is newly registered/edited/deleted by a processing flow similar to that shown in FIG. 41. When the data is registered in the priority patrol master DB 313, a priority flag corresponding to a priority map is set to “1” in the map master DB 303 (FIG. 4).

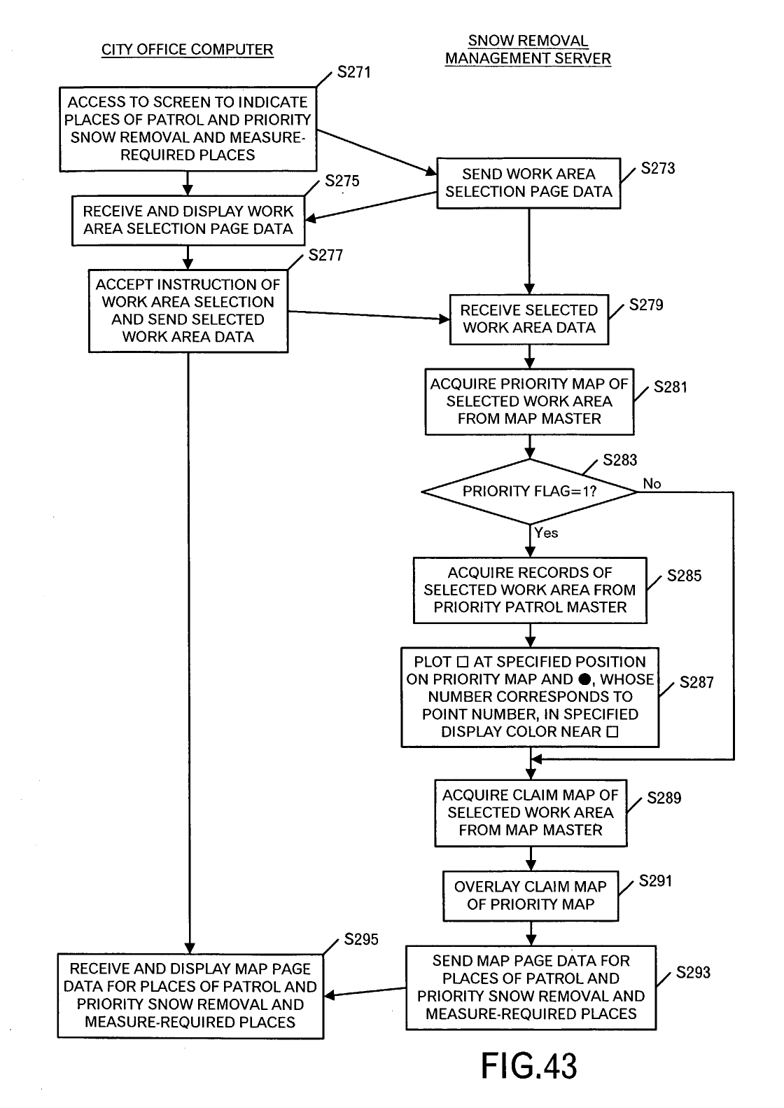

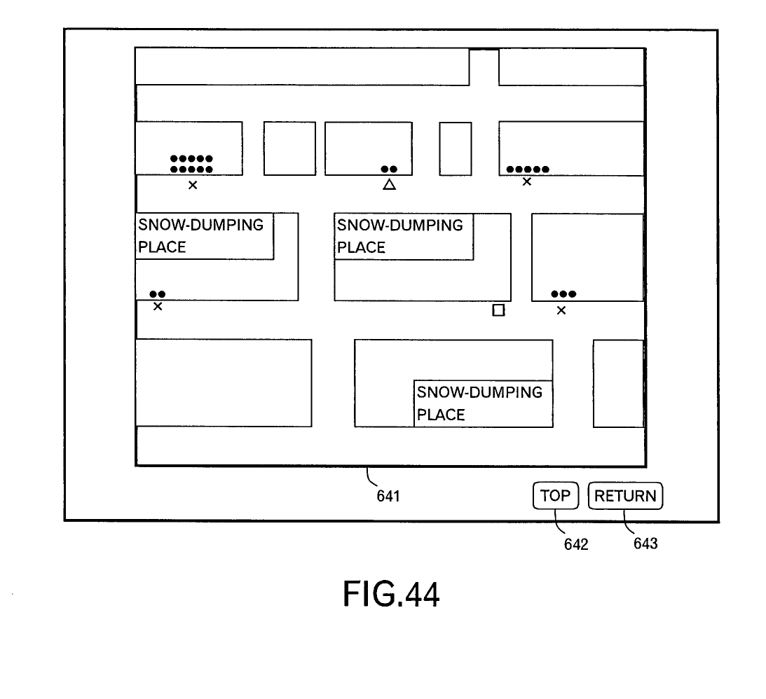

Next, a processing flow in the case where the button 603 for displaying a screen to indicate places of patrol and priority snow removal and measure-required places is clicked on the menu screen for the city office shown in FIG. 38 will be described by the use of FIGS. 43 and 44. In response to the click of the button 603, the city office computer 6 accesses a screen to indicate the places of patrol and priority snow removal and measure-required place (step S271). In response to the access, the snow removal planning processor 33 of the snow removal management server 3 transmits work area selection page data to the city office computer 6 (step S273). The city office computer 6 receives the work area selection page data from the snow removal management server 3, and displays it on the display device by the Web browser (step S275). For example, the screen as shown in FIG. 26 is displayed.

When the person responsible in the city office selects a work area to be displayed and clicks it, the city office computer 6 accepts the work area selection instruction, and transmits information of the work area selection instruction to the snow removal management server 3 (step S277). When the snow removal management server 3 receives the information of the work area selection instruction from the city office computer 6 (step S279), it acquires the priority map of the selected work area on the processing date from the map master DB 303 (FIG. 4) (step S281). Then, it is judged whether or not the priority flag corresponding to the priority map is set to 1 in the map master DB 303 (step S283). If the priority flag is zero, the processing proceeds to step S289.

On the other hand, when the priority flag is set to “1”, the record of the work area is read out from the priority patrol master DB 313 (step S285). Then, the snow removal planning processor 33 plots “□” icons at specified positions on the read priority map, and plots “•”, whose number corresponds to a point number, in a specified display color in the vicinity of the icon, and stores it in the storage device (step S287).

Besides, the snow removal planning processor 33 reads out the claim map of the selected work area from the map master DB 303 (step S289), overlays the claim map on the priority map, and stores them in the storage device (step S291). As described below, since data of the claim master DB 302 and data of the snowily weak person master DB 308 are plotted on the claim map by a batch processing (FIG. 47) at a predetermined timing, a plot processing is not carried out in this processing flow. Besides, there is also a case where the basic map is handled as a background and is further overlaid.

The snow removal planning processor 33 uses such generated map data to generate map page data of the places of the patrol and priority snow removal and measure-required places, and transmits it to the city office computer 6 (step S293). The city office computer 6 receives the map page data of the patrol and priority snow removal and measure-required places from the snow removal management server 3, and displays it on the display device by the Web browser (step S295).

FIG. 44 shows an example of a screen displayed on the city office computer 6 in this way. The example of FIG. 44 includes a column 641 for displaying a map of the places of the patrol and priority snow removal and measure-required places, a button 642 for returning to a top menu, and a button 643 for returning to the previous screen.

By such processing, the person responsible in the city office can grasp where complaints are voiced, where patrol spots are provided, and where snowily weak people exist.

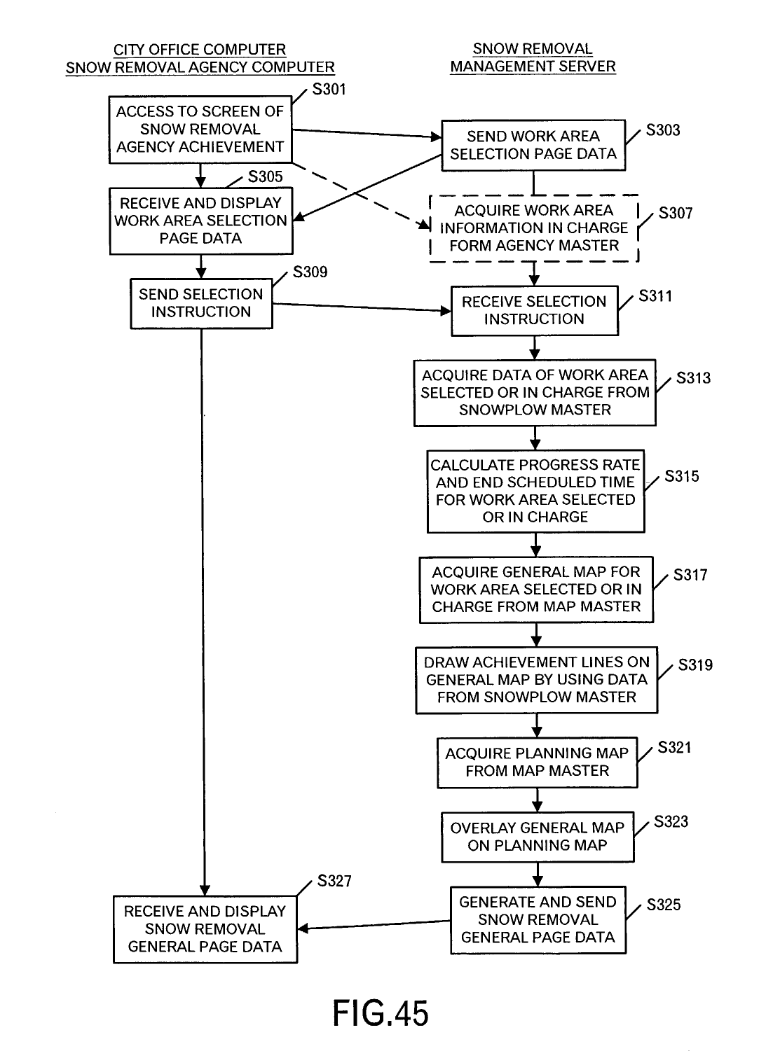

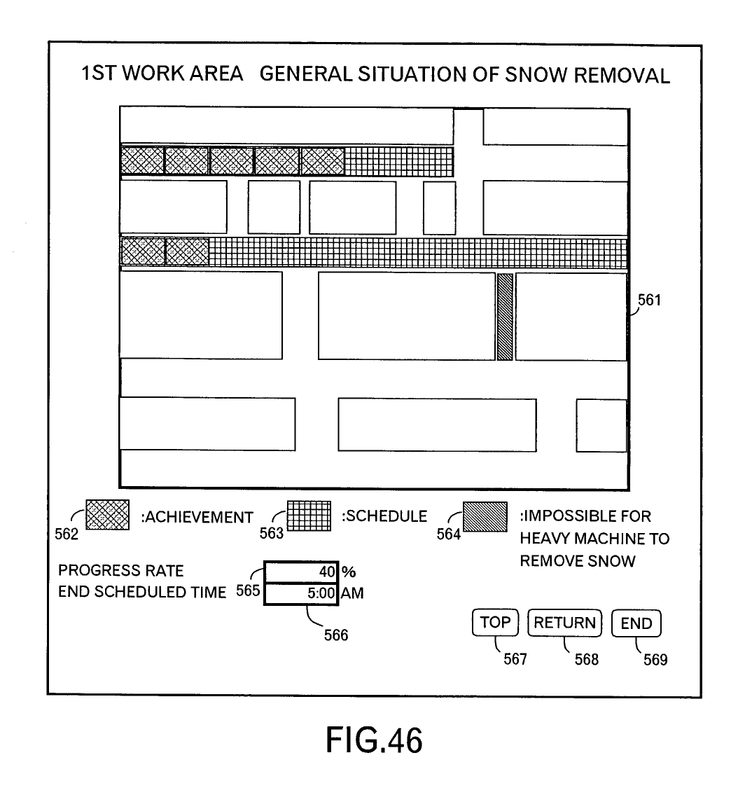

Next, processing in the case where the button 602 for displaying a screen for the achievement of the snow removal agency is clicked on the menu screen for the city office of FIG. 38 will be described by the use of FIGS. 45 and 46. Incidentally, this processing is also carried out in the case where the screen button 452 for displaying a screen for the achievement of the snow removal agency is clicked on the menu screen for the snow removal agency (FIG. 14).

When the button 405 or 452 is clicked, the city office computer 6 or the snow removal agency computer 8 accesses a snow removal agency actual achievement screen (step S301). In response to the access from the city office computer 6, the snow-removal achievement data processor 34 of the snow removal management server 3 transmits work area selection page data to the city office computer 6 (step S303). The city office computer 6 receives the work area selection page data from the snow removal management server 3, and displays it on the display device by the Web browser (step S305). For example, the screen as shown in FIG. 26 is displayed. The person responsible in the city office selects a work area in which an execution state of snow removal work is to be displayed. In response to the selection, the city office computer 6 transmits information of the selected work area to the snow removal management server 3 (step S309). The snow-removal achievement data processor 34 of the snow removal management server 3 receives the information of the selected work area from the city office computer 6, and stores it in the storage device (step S311).

Incidentally, in the case of the access from the snow removal agency computer 8, since it is not necessary to exhibit information other than the snow removal agency, the information of the work area in charge is acquired by referring to the agency master DB 307 (FIG. 6) (step S307).

Next, the snow-removal achievement data processor 34 reads out data of the work area selected or in charge from the snowplow master DB 309 (step S313). Then, a progress rate and an end scheduled time of the work area selected or in charge are stored in the storage device (step S315). Incidentally, the progress rate is calculated by [(achievement distance)/(snow removal scheduled distance)]×100. Besides, the end scheduled time is calculated by (start scheduled time)+(snow removal scheduled distance/ achievement distance per hour).

Besides, information of a general map of the work area selected or in charge is read out from the map master DB 303 (step S317). Then, an achievement line is drawn on the general map by using the data from the snowplow master DB 309, and is stored in the storage device (step S319) That is, the achievement line is drawn from the starting point X coordinate and the starting point Y coordinate to the end point X coordinate and the end point Y coordinate with consideration of the shape of a road. Besides, information of the planning map of the work area selected or in charge is read out from the map master DB 303 (step S321), and the general map with the achievement line is overlaid on the planning map and are stored in the storage device (step S323). Incidentally, at this stage, there is also a case where a scheduled line is drawn on the planning map by using the data of the schedule master DB 311. The snow-removal achievement data processor 34 generates snow removal general page data including the information calculated at the step S315 and the map information generated at the step S323, and transmits it to the city office computer 6 or the snow removal agency computer 8 (step S325). The city office computer 6 or the snow removal agency computer 8 receives the snow removal general page data and displays a screen, for example, as shown in FIG. 46 on the display device by the Web browser (step S327). FIG. 46 shows a screen example displayed at the step S327. Although FIG. 46 is almost identical to FIG. 34, the former is different from the latter in that an advertisement is not displayed. The example of FIG. 46 includes a map display column 561 for displaying a snow removal schedule and snow removal achievement, a hatching display example 562 of a snow removal achievement portion, a hatching display example 563 of a snow removal scheduled portion, a hatching display example 564 of a portion impossible for the heavy machine to remove snow, a display column 565 of a progress rate, a display column 566 of an end scheduled time, a button 567 for sifting to a top menu, a button 568 for returning to the previous screen, and a button 569 for ending the processing. By such display, the person responsible in the city office and the snow removal agency can grasp the snow removal schedule and the degree of the snow removal, which has been carried out up to now.

By doing so, the person responsible in the city office or the person responsible in the snow removal agency can grasp the present working state almost in real time.

In the above, the description has been given of the interactive processing of the citizen monitor computer 5, the city office computer 6, the citizen computer 7, and the snow removal agency computer 8. Hereinafter, processing executed in the background in the snow removal management server 3 will be described by the use of FIGS. 47 and 48.

FIG. 47 shows a processing flow of a batch processing of complaints (claims) or the like. This is such a processing that in addition to a normal complaint, information of a snowily weak person registered in the snowily weak person master DB 308 is mixed in the complaint and is exhibited without specifying the snowily weak person. The claim related processor 31 reads out data of snowfall from the initial value master DB 306 (FIG. 6) (step S351), and judges whether the snowfall is, for example, 15 cm or more (step S353). If it is less than 15 cm, it is judged that special consideration for the snowily weak people is not necessary, and the processing proceeds to step S363. However, there is also a case where such a judgment is not necessarily made.

If the snowfall is 15 cm or more, the snowily weak person information is read out from the snowily weak person master DB 308 (step S355). Then, a work area is specified from the address of the snowily weak person, and the claim map of the work area on a processing date is acquired from the map master DB 303 (step S357). Then, a point determination processing is carried out (step S359). The point determination processing will be described later by the use of FIG. 48. However, the point determination processing is not limited to the processing as shown in FIG. 48, and it is also possible for, for example, the person responsible in the city office to individually specify the point number for the snowily weak person. Further, the point determination processing is not carried out at this point of time, but the point number may be automatically determined at a predetermined timing correspondingly to the respective data items of the snowily weak person master DB 308 and the claim master DB 302.

Then, “□” is plotted on a road at the address of a snowily weak person on the claim map, “□”, whose number corresponds to the point value, is plotted in the vicinity of “□”, and the generated claim map is stored in the map master DB 303 (step S361). The display colors of “□” and “•” may be changed according to the point number. The number of “•” is changed so as to reflect the point number. Incidentally, “□” is the same symbol as the priority patrol spot, and by this, the location of the snowily weak person can not be known by only seeing the claim map. Incidentally, a structure may be such that “X” and “Δ” are plotted.

Next, the claim related processor 31 reads out the claim information from the claim master DB 302 (step S363). Besides, it reads out the claim map from the map master DB 303 (step S365). Next, it performs a point determination processing (FIG. 48) for the claim information (step S367). Then, it plots the display icon (“X” in the case of a snow clearing complaint, “Δ” in the case of a snow dumping complaint) at designated position coordinates on the claim map, and plots “•”, whose number corresponds to the point number, in a specified display color (depending on the point number) in the vicinity thereof, and stores the claim map generated in this way in the map master DB 303 (step S369). Then, in the map master DB 303, the claim flag corresponding to the claim map is set to “1” (step S371).

By carrying out the processing as described above, the information of the snowily weak person, together with the complaints from citizens, is plotted as the claim or priority patrol spot on the claim map, so that the position of the snowily weak person is not specified to the snow removal agency or the like. On the other hand, since it is automatically displayed as the complaint or priority patrol spot, the snow removal agency must carry out the snow removal while having consideration to the vicinity of the snowily weak person to some degree. As a result, it becomes possible to urge suitable snow removal in consideration of crime prevention.

Next, an example of the point determination processing will be described by the use of FIG. 48. In this embodiment, the claim related processor 31 reads out a today's weather code from the initial value master DB 306 (step S381). Besides, snow information for the past three days is read out from the initial value master DB 306 (step S383), and reference is made to the point table stored in the point table storage 310 on the basis of the today's weather and the information as to whether the snow accumulation is continuously increased for the three days, is continuously decreased for the three days, or is increased and decreased (step S385). Then, the respective claims and the point number concerning the snowily weak person information are acquired from the point table, and are registered in the clam master DB 302 or the snowily weak person master DB 308 (step S387).

It is one example to determine the point number by the processing as stated above, and the point number may be determined from another viewpoint.

Although the embodiment of the invention has been described, the invention is not limited to this. For example, in the functional block diagram shown in FIG. 1, although the functional block of the snow removal management server 3 is exemplified, such functional block structure is one example, and a program module is not necessarily divided in this way. Besides, in FIG. 1, although the number of each of the citizen monitor computer 5, the city office computer 6, the citizen computer 7, and the snow removal agency computer 8 is one, the number may be arbitrary. Similarly, there is also a case where all functions of the snow removal management server 3 are executed by not one computer but plural computers. Further, the same applies to the fixed camera 10 and the snowplow 9. The structure of the storage device is also one example, and also with respect to the data storage mode, the information necessary for carrying out the foregoing processing can be stored in any mode.

Although not described above, periodically or when the work completion report of each work area is registered, the information of complaints of the work area may be deleted from the claim master DB 302. Besides, in the processing flow of FIG. 48, although the point numbers in all cases are determined on the basis of the same point table, a structure may be such that the point number is changed according to a complaint informer or a snowily weak person.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. An information processing method associated with snow removal, comprising the steps of:
generating data indicating necessity of snow removal with a reason other than being a snowily weak person, based on at least position information of a registered snowily weak person; and
transmitting map information including said data indicating necessity of snow removal in response to a request from a terminal of a person relating to a snow removal plan.

2. The information processing method as set forth in claim 1, wherein said data indicating necessity of snow removal includes data based on a complaint from a citizen.

3. The information processing method as set forth in claim 1, wherein said data indicating necessity of snow removal includes data based on a spot to be monitored by a person responsible in a local government.

4. The information processing method as set forth in claim 1, wherein said data indicating necessity of snow removal includes data indicating a degree of necessity.

5. The information processing method as set forth in claim 4, wherein said data indicating a degree of necessity is determined based on a volume of snow accumulation or snowfall.

6. The information processing method as set forth in claim 1, further comprising a step of transmitting map information which enables to specify a scheduled area of snow removal work and includes said data indicating necessity of snow removal in response to a request from a terminal of a planner of snow removal plan.

7. The information processing method as set forth in claim 6, further comprising a step of receiving and storing into a storage device, information of a scheduled area of said snow removal work from said terminal of said planner of said snow removal plan.

8. The information processing method as set forth in claim 7, further comprising the steps of:
receiving and storing into a storage device, information concerning an execution state of said snow removal work; and
transmitting map information including said information of said scheduled area of said snow removal work and said information concerning said execution state of said snow removal work to a user terminal in response to a request from said user terminal.

9. The information processing method as set forth in claim 7, further comprising the steps of:
receiving and storing into a storage device, information concerning an execution state of said snow removal work; and
generating and transmitting information for a snow-removal work report based on said information concerning said execution state of said snow removal work to a terminal of an executer of said snow removal work in response to said terminal of said executer.

10. The information processing method as set forth in claim 1, wherein said map information includes indication of at least any of a snow-clearing spot, a snow-dumping spot, and a monitoring spot.

11. An information processing method associated with a snow removal plan, comprising the steps of:
transmitting a request for information concerning said snow removal plan to a server; and
receiving from said server and displaying on a display device, map information including position display of a notified claim and position display of a snowily weak person as data indicating necessity of snow removal with a reason other than being said snowily weak person.

12. A program embodied on a medium for causing a computer to perform an information processing associated with snow removal, said program comprising the steps of:
generating data indicating necessity of snow removal with a reason other than being a snowily weak person, based on at least position information of a registered snowily weak person; and
transmitting map information including said data indicating necessity of snow removal in response to a request from a terminal of a person relating to a snow removal plan.

13. The program as set forth in claim 12, wherein said data indicating necessity of snow removal includes data based on a complaint from a citizen.

14. The program as set forth in claim 12, wherein said data indicating necessity of snow removal includes data based on a spot to be monitored by a person responsible in a local government.

15. The program as set forth in claim 12, wherein said data indicating necessity of snow removal includes data indicating a degree of necessity.

16. The program as set forth in claim 12, further comprising a step of transmitting map information which enables to specify a scheduled area of snow removal work and includes said data indicating necessity of snow removal in response to a request from a terminal of a planner of snow removal plan.

17. The program as set forth in claim 16, further comprising a step of receiving and storing into a storage device, information of a scheduled area of said snow removal work from said terminal of said planner of said snow removal plan.

18. The program as set forth in claim 17, further comprising the steps of:
receiving and storing into a storage device, information concerning an execution state of said snow removal work; and
transmitting map information including said information of said scheduled area of said snow removal work and said information concerning said execution state of said snow removal work to a user terminal in response to a request from said user terminal.

19. The program as set forth in claim 17, further comprising the steps of:
receiving and storing into a storage device, information concerning an execution state of said snow removal work; and
generating and transmitting information for a snow-removal work report based on said information concerning said execution state of said snow removal work to a terminal of an executer of said snow removal work in response to said terminal of said executer.

20. An information processing apparatus associated with snow removal, comprising:
a generator for generating data indicating necessity of snow removal with a reason other than being a snowily weak person, based on at least position information of a registered snowily weak person; and
a transmitter for transmitting map information including said data indicating necessity of snow removal in response to a request from a terminal of a person relating to a snow removal plan.

21. The information processing apparatus as set forth in claim 20, wherein said transmitter transmits map information which enables to specify a scheduled area of snow removal work and includes said data indicating necessity of snow removal in response to a request from a terminal of a planner of snow removal plan.

22. The information processing apparatus as set forth in claim 21, further comprising a receiver for receiving and storing into a storage device, information of a scheduled area of said snow removal work from said terminal of said planner of said snow removal plan.

23. The information processing method as set forth in claim 22, wherein said receiver receives and stores into a storage device, information concerning an execution state of said snow removal work, and said transmitter transmits map information including said information of said scheduled area of said snow removal work and said information concerning said execution state of said snow removal work to a user terminal in response to a request from said user terminal.

24. The information processing apparatus as set forth in claim 22, wherein said receiver receives and stores into a storage device, information concerning an execution state of said snow removal work, and further comprising means for generating information for a snow-removal work report based on said information concerning said execution state of said snow removal work in response to a terminal of an executer of said snow removal work, and wherein said transmitter transmits said information for a snow-removal work report to said terminal of said executer.
